(19) United States
(12) Patent Application Publication
(10) Pub. No.: US 2025/0162892 A1
(43) Pub. Date: May 22, 2025

(54) METHOD TO PURIFY Li2CO3 AND MAKE LiF FOR MANUFACTURING LiPF6

(71) Applicant: Mexichem Fluor Inc., St. Gabriel, LA (US)

(72) Inventors: Maxine Doran, Chester (GB); Marcus Lancashire, Chester (GB); Gary Lloyd, Chester (GB); Ben Murray, Chester (GB); Claire Rees, Chester (GB); Stephane Rouanet, Chester (GB); Andy Sharratt, Chester (GB); Joshua Walton, Chester (GB)

(21) Appl. No.: 18/950,275

(22) Filed: Nov. 18, 2024

Related U.S. Application Data
(60) Provisional application No. 63/600,307, filed on Nov. 17, 2023.

(51) Int. Cl. C01D 15/04; C01B 7/03; C01B 25/10; C01D 7/10; C01D 7/26; C01D 15/08

(52) U.S. Cl. CPC C01D 15/04; C01B 7/035; C01B 25/10; C01D 7/10; C01D 7/26; C01D 15/08; C01P 2002/82; C01P 2004/02; C01P 2004/03; C01P 2004/61

(57) ABSTRACT

A method to make LiF crystals by simultaneously adding aqueous LiHCO₃ and HF to a stirred reactor containing water or a solution of LiF. The method yields LiF crystals having a Dv50 particle size of from about 60 μm to about 90 μm.

### CROSS-REFERENCE TO RELATED APPLICATIONS

Priority is hereby claimed to provisional application Ser. No. 63/600,307, filed Nov. 17, 2023, which is incorporated herein by reference.

### BACKGROUND

Lithium carbonate (Li₂CO₃) is one of the key raw materials for the manufacture of various battery electrolyte salts, including lithium hexafluorophosphate (LiPF₆), lithium bis(fluorosulfonyl)imide (LiFSI), and lithium bis(trifluoromethanesulfonyl)imide (LiTFSI). The source of the Li₂CO₃ is, by far, the largest contributing factor to variable-cost operating expenses incurred in the production of high-purity lithium electrolyte salts. Less expensive grades of Li₂CO₃ are readily available. But the Li₂CO₃ required to synthesize battery-grade lithium electrolyte salts (LiPF₆, LiFSI, LiTFSI, etc.) must itself be of very high purity. Therefore, some form of purification process is required when starting with lower grades of Li₂CO₃ to make battery-grade lithium electrolyte salts.

As a general proposition, to arrive at battery-grade lithium electrolyte salts, the feedstock Li₂CO₃ should not exceed certain upper specification limits for a host of potential contaminants, including sulfate, nitrate, phosphate, sodium, potassium, magnesium, chlorine, fluorine, and many others. These upper specification limits are all typically at or below 50 ppm, and for metals such as iron, nickel, copper, and others, at or less than 10 ppm.

Conventional methods to purify Li₂CO₃ follow the same basic procedure as shown in FIG. 1. Lithium carbonate (Li₂CO₃) is sparingly soluble in water (12.9 g/L at 20° C.) and so a slurry is first prepared. The slurry is then reacted in a continuous process with CO₂ to generate lithium bicarbonate, LiHCO₃, which is soluble up to ˜60 g/L, but is metastable. Because LiHCO₃ is metastable, it cannot be isolated as a solid, heated above 40° C. or allowed to stand for too long without a protective blanket of CO₂ to prevent its decomposition back to Li₂CO₃. Ion exchange is then used to remove heavier contaminating ions such as calcium and magnesium (which are the most concerning elements for typical virgin lithium carbonate sources derived from brines or ores. Finally, the LiHCO₃ solution is decomposed to generate purified Li₂CO₃ solids that can be isolated by filtration. This removes lighter impurities such as sodium that are not captured by the ion exchange resin but remain in solution during the filtration step. See, for example, U.S. Pat. No. 8,691,169, issued Apr. 8, 2014, to Perez et al. and U.S. Pat. No. 8,435,468, issued May 7, 2013, to Harrison et al.

### SUMMARY

Disclosed herein is a method to make LiF crystals. The method comprises simultaneously adding aqueous LiHCO₃ and HF to a reactor containing water. The water in the reactor may be simply deionized water or a solution of LiF. The solution of LiF may be saturated with LiF. The aqueous LiHCO₃ and HF may be added to the reactor from either above the surface of the water in the reactor or from below the surface of the water. The method yields LiF crystals having a Dv50 particle size of from about 60 μm to about 90 μm.

The method may further comprise adding LiF seed crystals to the reactor. The LiF seed crystals may have a Dv50 of from about 3 μm to about 100 μm.

The aqueous LiHCO₃ can be generated by reacting Li₂CO₃ with CO₂, and the Li₂CO₃ may be technical grade.

The aqueous LiHCO₃ may be purified to remove various impurities prior to adding to the reactor. This includes filtering the aqueous LiHCO₃ through a filter having a nominal pore size of about 1 μm or less prior to adding the aqueous LiHCO₃ to the reactor. The method may further comprise centrifuging the aqueous LiHCO₃ prior to the filtering, and adding a flocculant to the aqueous LiHCO₃ prior to the centrifuging. The centrifugation and filtration process removes aluminium and phosphorus from the aqueous LiHCO₃.

The method may further comprise passing the aqueous LiHCO₃ through an ion exchange resin prior to adding the aqueous LiHCO₃ to the reactor, wherein the ion exchange resin is regenerated with LiOH. The ion exchange removes cations such as calcium and magnesium. Regenerating the ion exchange resin with LiOH instead of NaOH prevents introducing additional sodium to the aqueous LiHCO₃.

The method may further comprise adding a chelation of iron to the aqueous LiHCO₃ prior to adding the aqueous LiHCO₃ to the reactor. This removes iron resulted from corrosion of steel equipment or some unknown sources.

Also disclosed herein is a method to make HCl. The method comprises reacting PCl₃, Cl₂, and HF to yield PF₅ and HCl and recovering at least a portion of the HCl from reactor effluent off-gas. The HCl may be recovered in anhydrous form or as an aqueous solution.

The objects and advantages of the invention will appear more fully from the following detailed description of the preferred embodiment of the invention made in conjunction with the accompanying drawings.

### BRIEF DESCRIPTION OF THE DRAWINGS

FIG. 1. Schematic representation of conventional Li₂CO₃ purification process.

FIGS. 2A and 2B. Ion chromatography (IC) spectrum of battery grade (Ascend Elements) Li₂CO₃ in water before purification (FIG. 2A) and after purification (FIG. 2B).

FIGS. 3A and 3B. Photomicrographs of battery grade Li₂CO₃ crystals before purification (FIG. 3A) and after purification (FIG. 3B).

FIGS. 4A and 4B. Ion chromatography (IC) spectrum of technical grade (Ascend Elements) Li₂CO₃ in water before purification (FIG. 4A) and after purification (FIG. 4B).

FIG. 5. Number of particles under 50 μm formed during a reaction of LiF and LiHCO₃.

FIG. 6. Number of particles between 70-300 μm detected during a reaction of LiF and LiHCO₃.

FIG. 7. pH over time for a reaction of LiF and LiHCO₃ taken from Ava data.

FIG. 8. Precipitation of Li₂CO₃ from LiHCO₃ solution at elevated temperature.

FIG. 9. Consistency in particle size of LiF observed over multiple experiments.

FIG. 10. Change in particle size moving between the two reactors determined by laser diffraction.

FIGS. 11A and 11B. Change in LiF morphology with temperature observed by optical microscopy at 10×. FIG. 11A taken at 5° C. FIG. 11B taken at 20° C.

FIG. 12. Impact of seeding on product LiF particle size distribution.

FIG. 13. Photomicrograph at 10× of LiF formed by addition of LiHCO₃ into HF.

FIGS. 14A and 14B. Infrared spectra of LiF formed from saturated Li₂CO₃ solution (FIG. 14A) and supersaturated Li₂CO₃ slurry (FIG. 14B) with characteristic carbonate absorption peak circled.

FIG. 15. pH over time for a reaction of HF and Li₂CO₃ to form LiF taken from Ava data and possible reactions taking place at each inflection point.

FIG. 16. Comparison of particle size distribution for LiF made by mixed addition (87.5 μm) to two commercial LiF samples (84.2 μm and 96.3 μm).

FIG. 17. Photomicrograph at 10× magnification of LiF particles obtained by mixed addition.

FIG. 18. Particle sizes of LiF initially obtained from 10 L scale reactions.

FIG. 19. Comparison of LiF particle size results from 1 L and 10 L scale reactions.

FIG. 20. Comparison of LiF particle size results from 1 L and 50 L scale reactions.

FIGS. 21A, 21B, 21C, 21D, 21E, and 21F. Relationships between particle size (Dv5) and operating parameters across all scales. FIG. 21A=impeller tip velocity. FIG. 21B=HF inlet velocity. FIG. 21C=impeller: vessel diameter ratio. FIG. 21D=tank heel volume. FIG. 21E=bicarbonate inlet velocity. FIG. 21F=% bicarbonate addition relative to HF.

FIG. 22. Sodium concentration in water through Na-dosed LiF crystallisation process.

FIG. 23. Sodium concentration in LiF solids after different amounts of washing.

FIGS. 24A and 24B. Lithium levels (FIG. 24A) and sodium levels (FIG. 24B) in wash water from successive washes of LiF with water.

FIG. 25. Concentration of sodium in LiF solids with different levels of sodium dosing.

FIGS. 26A, 26B, 26C, and 26D. LiF morphology as determined by optical microscopy; 449 ppm (FIG. 26A), 681 ppm (FIG. 26B), 1130 ppm (FIG. 26C), and 403 ppm (FIG. 26D).

FIG. 27. Effect of particle size on concentration of sodium impurity in LiF solids.

FIG. 28. Effect of sodium dosing on sodium in product.

FIGS. 29A and 29B. Example LiF crystal morphology by SEM that leads to passing (FIG. 29A) or failing (FIG. 29B) a test for carbonate contamination.

FIG. 30. Effect of cooling coil corrosion on LiF particle size at 10 L scale.

FIG. 31. Effect of bicarbonation reactor corrosion on LiF particle size at 50 L scale.

FIGS. 32A and 32B. Cations present in water before (FIG. 32A) and after (FIG. 32B) passing through bicarbonation rig measured by ion chromatography; peaks assigned based on retention times.

FIG. 33. Relationship between iron concentration and LiF particle size.

FIGS. 34A and 34B. LiF particle morphology with 0.2 ppm Fe (FIG. 34A) and 1.0 ppm Fe (FIG. 34B).

FIG. 35. Graph of removal of aluminum from lithium bicarbonate by simple filtration. Simple filtration using a filter with a nominal pore size below about 1 μm results in significant reduction of aluminum in the lithium bicarbonate.

FIG. 36. Graph showing calcium concentration in the effluent as a function of bed volumes for ion exchange chromatography using Lanxess Lewatit Monoplus TP208-brand resin at 25° C.

FIG. 37. Graph showing magnesium concentration in the effluent as a function of bed volumes for ion exchange chromatography using Lanxess Lewatit Monoplus TP208-brand resin at 25° C.

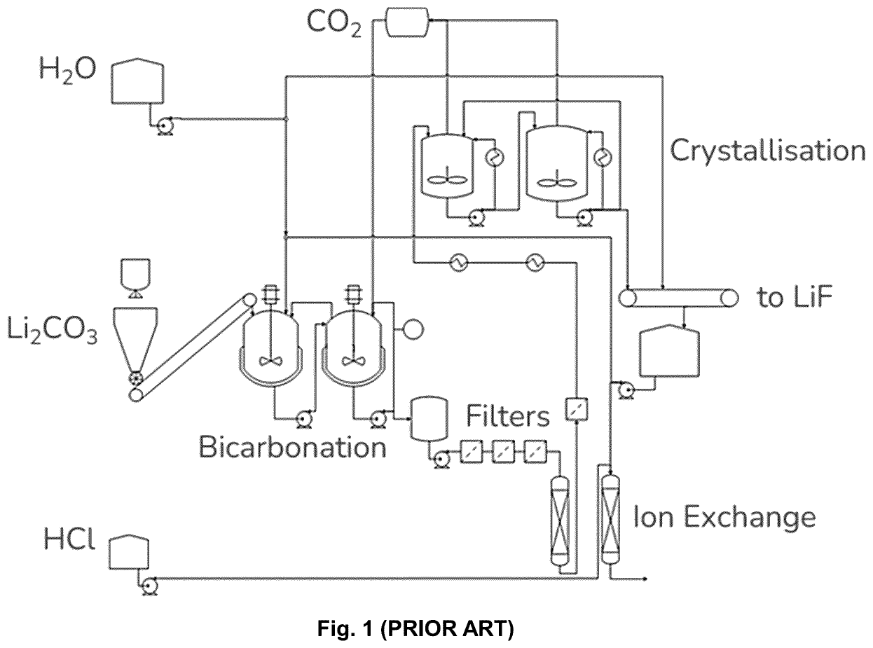

### DETAILED DESCRIPTION

### Abbreviations and Definitions

All references to singular characteristics or limitations of the disclosed method shall include the corresponding plural characteristic or limitation, and vice-versa, unless otherwise specified or clearly implied to the contrary by the context in which the reference is made. The indefinite articles “a” and “an” mean “one or more.” The word “or” is used inclusively, and should be read as “and/or.”

All combinations of method steps disclosed herein can be performed in any order, unless otherwise specified or clearly implied to the contrary by the context in which the referenced combination is made.

The method disclosed herein can comprise, consist of, or consist essentially of the essential elements and steps described herein, as well as any additional or optional ingredients, components, or limitations described herein or otherwise useful in inorganic chemistry. The disclosure provided herein suitably may be practiced in the absence of any element which is not specifically disclosed herein.

CFD=computational fluid dynamics. FEP=fluorinated ethylene propylene. IC=ion chromatography. ICP-OES=inductively coupled plasma-optical emission spectroscopy. SEM=scanning electron microscopy. TGA=thermogravimetric analysis.

As used herein “HF” refers to either/both anhydrous HF (hydrogen fluoride) and aqueous solutions of HF (hydrofluoric acid).

The term “lithium electrolyte salts” is defined broadly herein to refer to any lithium-containing salt that finds use in electrolyte formulations for lithium-ion batteries. The term “lithium electrolyte salts” explicitly includes, but is not limited to, LiPF₆ (lithium hexafluorophosphate), LiFSI (lithium bis(fluorosulfonyl)imide), LiTFSI (lithium bis(trifluoromethane)sulfonimide), and the like.

### Overview of the Method

Newly developed and disclosed herein is a method of purifying lithium carbonate (Li₂CO₃) and controlling the particle size of lithium fluoride (LiF) made from the lithium carbonate (or lithium bicarbonate, LiHCO₃). The resulting LiF is useful for making high-purity (i.e., “battery-grade”) lithium electrolyte salts, including, but not limited to LiPF₆, LiFSI, and LiTFSI.

In particular, the method relies on using a lower quality of lithium carbonate than would conventionally be used for making high-grade lithium electrolyte salts, including Li₂CO₃ from recycled lithium-ion batteries. The first step is to purify the Li₂CO₃. This is accomplished via converting the Li₂CO₃ to LiHCO₃, performing ion exchange of the LiHCO₃ solution to remove various impurities, and then thermally decomposing the LiHCO₃ back into purified Li₂CO₃.

The next step is to react the purified Li₂CO₃ (or the purified LiHCO₃) with HF to yield LiF. The proper particle size is achieved via close control of the order of addition and rate of addition of the reactants, the rate of mixing, and temperature. As a general proposition, it was found that larger particles (70-80 microns) were achieved by co-feeding LiHCO₃ and HF at the same time into water. In some instances, larger particles are more desirable because they have better flowability, thereby avoiding blockages in the material handling equipment.

Where smaller particles are desired (40-60 microns), it was found that particles of this size were made by adding HF into LiHCO₃, and using a ramping addition rate of HF (either by increasing the addition rate of same concentration volumetrically or increasing the HF concentration). Smaller particles are desirable in some cases because they contain less occluded water and react faster in the subsequent reaction to make lithium electrolyte salts.

Chelating agents may also be used both to remove impurities and to produce optimum crystal size and morphology.

By controlling the upstream inputs relevant to making LiF, the downstream reaction of LiF with PF₅ to yield LiPF₆ is improved. In short, using the present method, lower-quality Li₂CO₃ can be used to make very high-purity LiPF₆. As a value-added by-product stream, the synthesis of PF₅ produces HCl, which can be isolated and sold as a by-product of LiPF₆ manufacture.

### Purifying Lithium Carbonate

Purification of various grades of Li₂CO₃ have been evaluated to determine how effectively they can be purified for use in the manufacture of lithium electrolyte salts. Li₂CO₃ (18 g) was suspended in deionized water (300 mL) in a Parr autoclave (450 mL) (Parr Instrument Company, Moline, Illinois, USA) fitted with overhead stirrer and thermocouple. A cylinder of CO₂ was connected to the vessel and the reaction was padded with 10 bar of CO₂, which was maintained throughout the reaction. The reaction mixture was stirred at 200 rpm for at least 40 h at room temperature. The autoclave was opened and a fizzing clear liquid (LiHCO₃ solution) was extracted into an FEP bottle.

The LiHCO₃ solution was then pumped through an ion exchange column (Purolite®-brand S9320 ion exchange resin; Purolite, An Ecolab Company, King of Prussia, Pennsylvania, USA) at a rate of 1 L/h (column regenerated with 7.5% HCl solution and conditioned with 4% LiOH solution). Parallel reactions were also run using Lewatit® MonoPlus-brand TP208 resin (Lanxess AG, Cologne, Germany). The first bed volume's worth of LiHCO₃ solution was discarded, and the rest was collected for further use. The conductivity before ion exchange was about 46.0 mS cm⁻¹ and after was about 43.5 mS cm⁻¹, which is consistent with a drop in ion concentration.

The LiHCO₃ solution was transferred to a 1 L Radleys glass reactor (R.B. Radley & Co Ltd, Shire Hill, Saffron Walden, Essex, CB11 3AZ, UK) fitted with overhead stirrer (anchor impeller) and temperature probe. The mixture was heated to 85° C. for 1.5 h and Li₂CO₃ precipitated out of solution (accompanied by evolution of CO₂). The suspension was allowed to cool to room temperature and extracted using the drain tap on the reactor. The wet solids were then filtered under vacuum through filter paper (Whatman® 5-brand; Global Life Sciences Solutions Operations UK Ltd., Sheffield, UK) and the extracted solid was transferred to a crystallization dish and weighed. The solid was dried overnight in an oven (105° C.) and weighed again to determine the final yield of the product (about 35-59%). The product was analyzed by ion chromatography and ICP-OES.

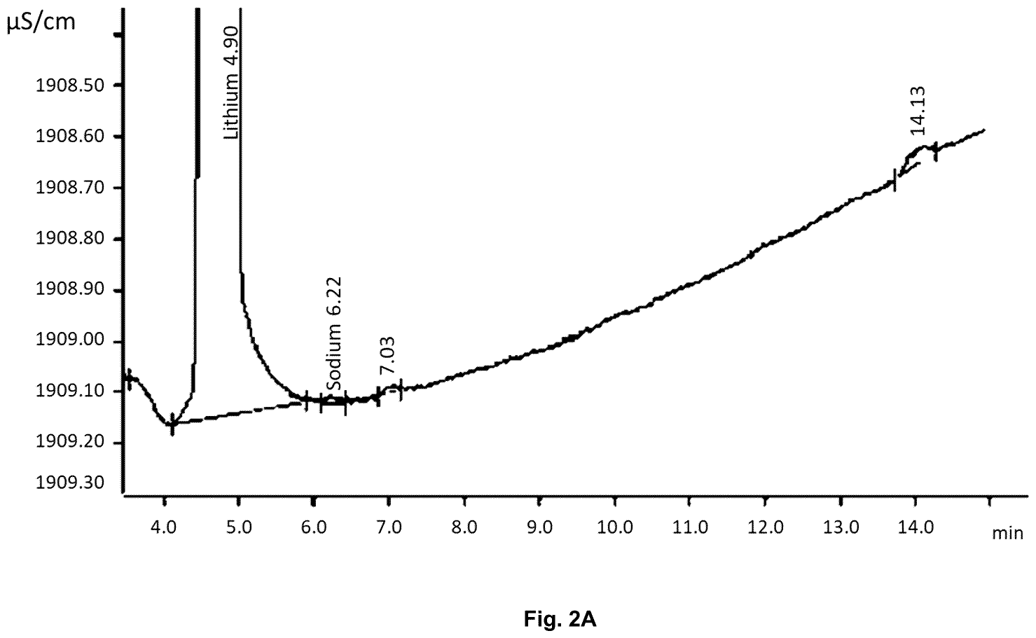

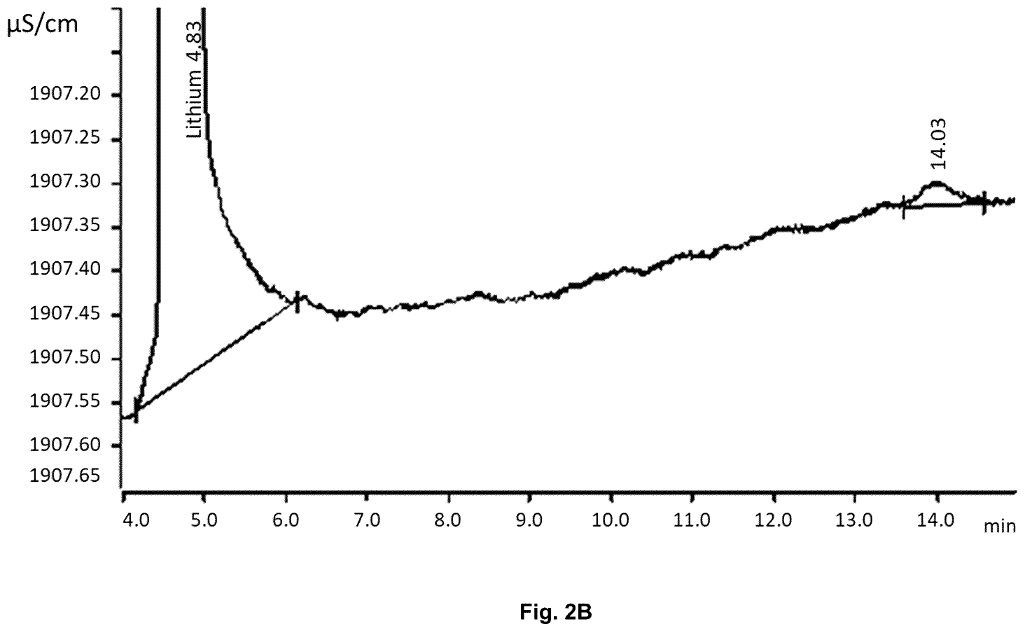

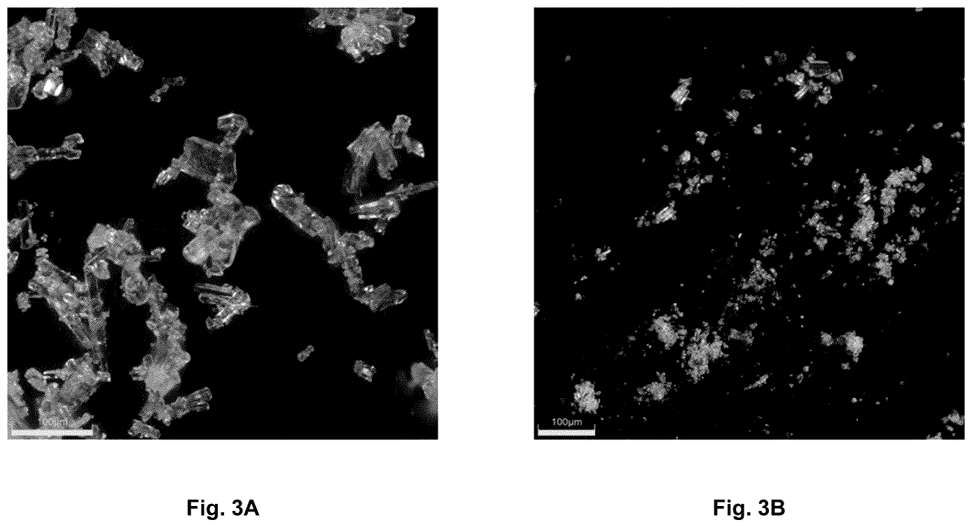

In an exemplary run using a battery grade Li₂CO₃ (Ascend Elements, Westborough, MA, USA), the initial bicarbonation reaction went to completion in about 40 hours. The thermal decomposition reaction of LiHCO3 was stirred at 80° C. for 70 mins, then cooled for an hour. The suspension was filtered and 14.6 g of Li₂CO₃ was extracted by filtration. This was dried for 3 days at 105° C. and the mass reduced to 10.8 g, giving a final yield of 59%. The purified Li₂CO₃ was dissolved in water and analyzed by ion chromatography (“IC”). See FIGS. 2A (before purification) and 2B (after purification). These spectra indicate a reduction in the concentration of sodium ions in the purified Li₂CO₃, a key aim of the purification. The resulting Li₂CO₃ was also much finer after purification, as revealed by microscopy. See FIGS. 3A and 3B, which show the Li₂CO₃ before and after purification, respectively.

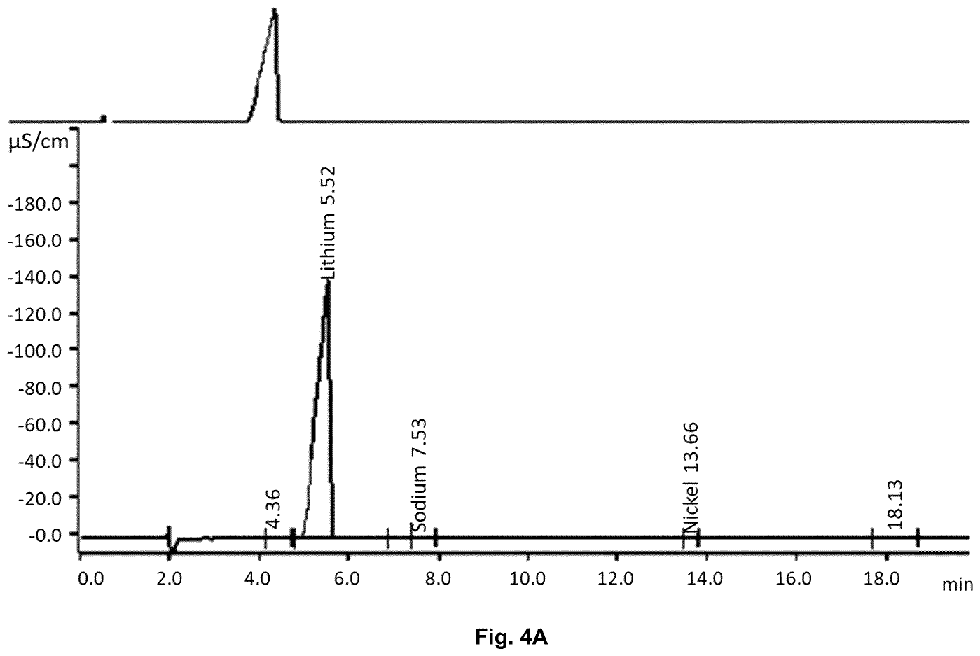

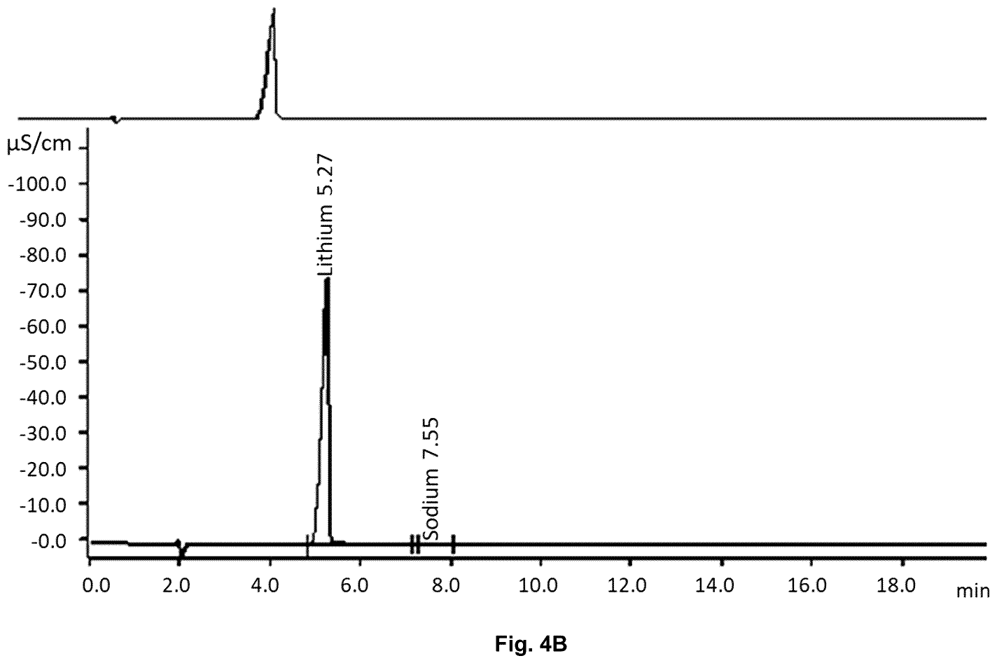

The same reactions were conducted using a technical grade Li₂CO₃ (Ascend Elements, Westborough, MA, USA). Here, the initial bicarbonation reaction was run for 42.5 hours, which yielded quantitative conversion to LiHCO₃. The LiHCO₃ solution was passed through the ion exchange resin, decomposed back to Li₂CO₃, filtered and dried overnight to yield 9.8 g of purified Li₂CO₃. (The yield was reduced due to the use of a different grade of filter paper, leading to some material passing through). The purified lithium carbonate was again analyzed by IC, the spectra for which are shown in FIGS. 4A (before purification) and 4B (after purification). The IC spectra indicates that nickel was eliminated from the lithium carbonate, nickel being a known contaminant in this specific source of lithium carbonate. FIGS. 4A and 4B also show that the concentration of sodium has been reduced by a factor of 3. This is a significant improvement.

A third purification reaction was run using a different commercially sourced technical grade Li₂CO₃ (Allkem Ltd., Buenos Aires, Argentina). The bicarbonation reaction was carried out for 48 h and the LiHCO₃ solution was passed through the ion exchange resin following the procedure described hereinabove. The decomposition was carried out at 85° C. for 2 h and was left to cool overnight. The yield of Li₂CO₃, post-drying, was 35%.

Lithium carbonate samples purified as described above were analyzed by inductively coupled plasma—optical emission spectroscopy (ICP-OES). The samples were compared to a standard solution containing 24 elements (Al, As, B, Ba, Ca, Cd, Ce, Co, Cr, Cu, Fe, Hg, K, Mg, Mn, Mo, Na, Ni, P, Pb, S, Si, Sr, Ti, V, and Zn.) All except boron were analyzed successfully. (Quantification of boron was distorted by the presence of boron in the glassware used to make the samples.) The results are shown in Table 1.

The ICP-OES data indicate that several impurities have been removed by the purification process disclosed herein. Chromium was successfully reduced to below specification levels in all samples. Nickel was removed from the Ascend Elements Li₂CO₃, where it is a significant contaminant.

TABLE 1
ICP results of pre- and post-purification of various grades of lithium carbonate.

| | | Battery Grade | | High quality | Ascend | Ascend | Ascend | Ascend | Allkem | Allkem |
|---|---|---|---|---|---|---|---|---|---|---|
| | | Li₂CO₃ | Purified | Li₂CO₃ | Battery | Battery | Technical | Technical | Technical | Technical |
| | | (requires | battery | (without | Grade Pre | Grade Post | Grade Pre | Grade Post | Grade Pre | Grade Post |
| Item | Unit | purification) | grade | purification) | Purification | Purification | Purification | Purification | Purification | Purification |
| Al | ppm | ≤10 | ≤4 | ≤5 | 1.228 | 0.46 | 0.513 | 0.54 | 6.383 | 8.391 |
| As | ppm | ≤2 | ≤1 | ≤2 | 0.757 | 1.239 | 0.941 | 0.86 | 0.851 | 1.1 |
| B | ppm | ≤10 | ≤5 | ≤10 | failed | failed | failed | failed | failed | failed |
| Ba | ppm | ≤8 | ≤4 | ≤3 | 0.273 | 0.022 | 0.053 | 0.526 | 0.467 | 0.091 |
| Ca | ppm | ≤160 | ≤4 | ≤90 | 10.181 | 10.35 | 19.844 | 72.394 | 12.554 | 10.684 |
| Cd | ppm | ≤1 | ≤1 | ≤1 | not detected | not detected | not detected | not detected | not detected | not detected |
| Ce | ppm | ≤3 | ≤3 | ≤3 | not in | not in | not in | not in | not in | not in |
| | | | | | standard | standard | standard | standard | standard | standard |
| Co | ppm | ≤1 | ≤1 | ≤1 | not in | not in | not in | not in | not in | not in |
| | | | | | standard | standard | standard | standard | standard | standard |
| Cr | ppm | ≤3 | ≤1 | ≤3 | 2.078 | 0.623 | 0.515 | 0.11 | 3.176 | 0.015 |
| Cu | ppm | ≤10 | ≤1 | ≤3 | 0.112 | 0.163 | 0.293 | 0.127 | 0.126 | 1.27 |
| Fe | ppm | ≤10 | ≤4 | ≤3 | 1.689 | 0.592 | 0.862 | 1.54 | 3.012 | 0.676 |
| Hg | ppm | ≤1 | ≤1 | ≤1 | 0.183 | 0.358 | 0.255 | 0.22 | 0.227 | 0.27 |
| K | ppm | ≤50 | ≤10 | ≤10 | 10.648 | 55.698 | 6.459 | 12.183 | 30.67 | 8.964 |
| Mg | ppm | ≤100 | ≤2 | ≤40 | 1.083 | 0.633 | 7.05 | 42.119 | 1.669 | 0.841 |
| Mn | ppm | ≤5 | ≤2 | ≤5 | 0.003 | not detected | not detected | not detected | 0.168 | 0.836 |
| Mo | ppm | ≤1 | ≤1 | ≤1 | not in | not in | not in | not in | not in | not in |
| | | | | | standard | standard | standard | standard | standard | standard |
| Na | ppm | ≤840 | ≤20 | ≤50 | 3.935 | 30.012 | 8.97 | 78.724 | 12.622 | 2.525 |
| Ni | ppm | ≤10 | ≤5 | ≤3 | 0.572 | 0.105 | 2.786 | 0.183 | 2.082 | 7.693 |
| P | ppm | ≤25 | ≤20 | ≤15 | 16.204 | 4.722 | 3.615 | 27.775 | 108.688 | 152.725 |
| Pb | ppm | ≤10 | ≤1 | ≤5 | N.D. | 0.023 | N.D. | 0.074 | N.D. | 0.45 |
| S | ppm | ≤200 | ≤15 | ≤90 | not in | not in | not in | not in | not in | not in |
| | | | | | standard | standard | standard | standard | standard | standard |
| Si | ppm | ≤200 | ≤25 | ≤140 | not in | not in | not in | not in | not in | not in |
| | | | | | standard | standard | standard | standard | standard | standard |
| Sr | ppm | ≤14 | ≤4 | ≤2 | 0.037 | not detected | 0.748 | 5.531 | 0.045 | not detected |
| Ti | ppm | ≤1 | ≤1 | ≤1 | 0.041 | 0.092 | 0.1 | 0.552 | 0.083 | 0.032 |
| V | ppm | ≤4 | ≤4 | ≤4 | not in | not in | not in | not in | not in | not in |
| | | | | | standard | standard | standard | standard | standard | standard |
| Zn | ppm | ≤10 | ≤1 | ≤1 | 3.08 | 2.622 | 2.17 | 2.018 | 2.398 | 2.205 |

### Producing Lithium Fluoride from Lithium Bicarbonate

LiF is a key compound in the supply chain for lithium-ion batteries. It is also a precursor to the electrolyte salts LiPF₆, LiFSI, and LiTFSI. Both the purity and the particle size of LiF are relevant to the fabrication of battery-grade lithium electrolyte salts. Disclosed herein is a method of making suitably pure, suitably sized LiF for the manufacture of lithium electrolyte salts in general. Fabrication of the lithium electrolyte salt LiPF₆ is used as a representative lithium electrolyte salt in the working examples contained herein.

Synthesis of LiF has been developed using Li₂CO₃ as the initial source of lithium. Due to the low aqueous solubility of Li₂CO₃, bicarbonation to generate LiHCO₃ has been used to bring more lithium in solution to then react with HF to form LiF. The key chemical reactions to LiPF₆ are as follows:

Li₂CO₃+CO₂+H₂→2LiHCO₃

LiHCO₃+HF→LiF+CO₂+H₂O

LiF+PF₅→LiPF₆

While formation of LiF is facile, controlling the crystallization to generate particles of the appropriate size (Dv50 of about 70 to about 90 μm) proved more challenging.

Key variables were evaluated for controlling crystallization of lithium fluoride to form particles of a size suitable for subsequent transformation into LiPF₆. Lithium bicarbonate solutions were prepared at as close to saturation as possible, approximately 65 g/L, by the batch reaction of commercially obtained lithium carbonate (Allkem) with CO₂ in a Parr vessel at 25° C. LiHCO₃ solutions were prepared immediately before their reaction with HF.

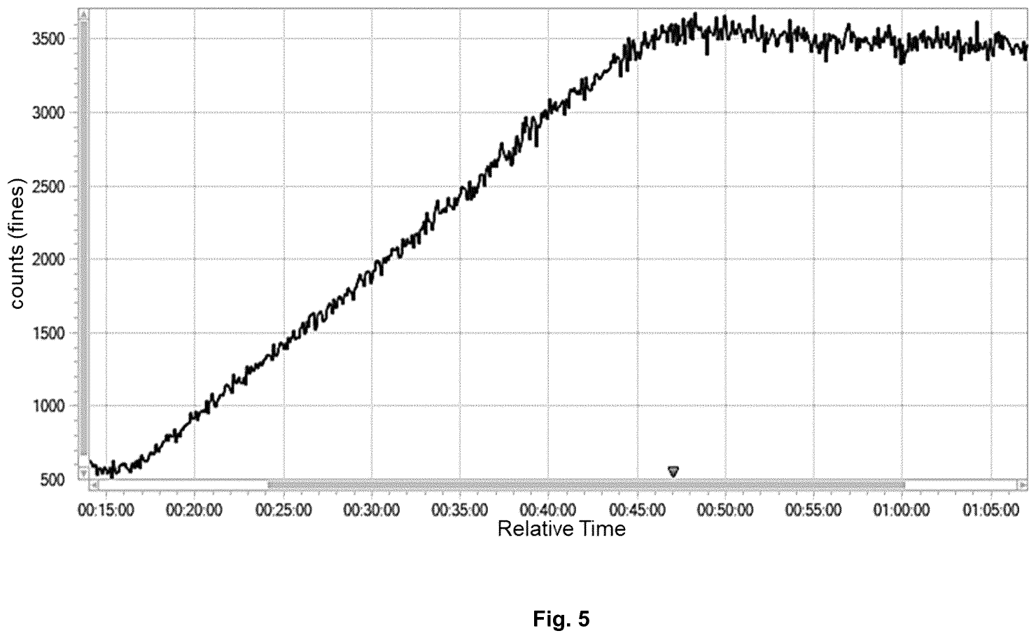

Most reactions were carried out in a 1 L Radleys jacketed glass vessel with an overhead stirrer and a chiller controlled remotely by Ava software (from Radleys). Addition of HF using either a peristaltic or syringe pump could also be controlled remotely. Real-time feedback was obtained from the pH and temperature probes in the same software. As HF was added to the stirred solution of LiHCO₃, precipitation of the LiF product alongside evolution of CO₂ was immediately visible. Particle size was measured in situ using a Mettler Toledo Particle Track G400 probe (Mettler Toledo, Greifensee, Switzerland). For a typical reaction, FIG. 5 shows how, on addition of HF, there is a large increase in the number of particles <50 μm, which corresponds to the rapid precipitation of LiF from the solution. As the reaction progresses, the number of these particles increases before eventually levelling off once the endpoint is reached.

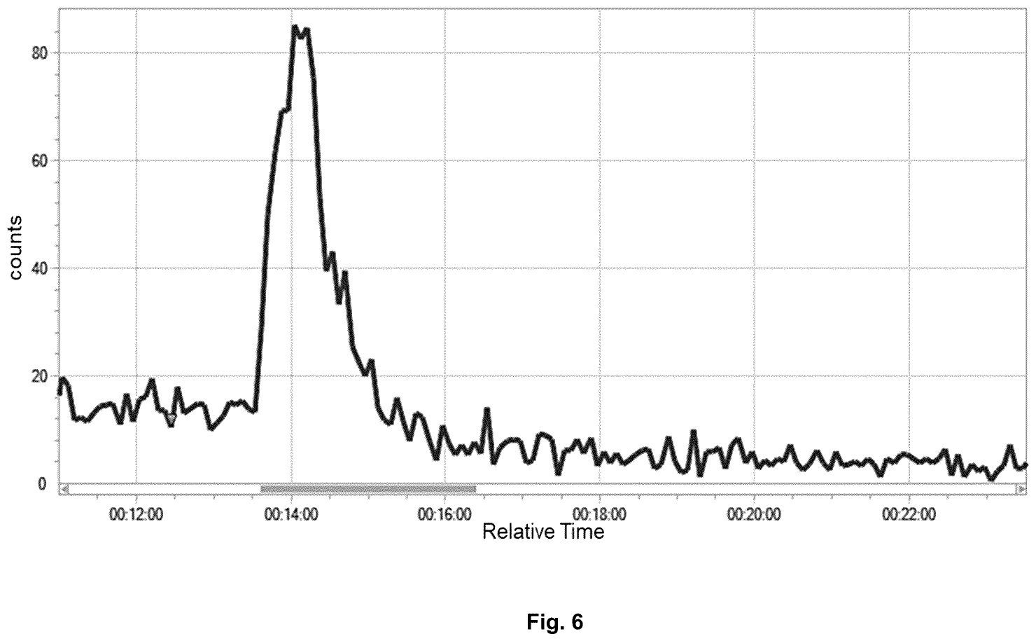

FIG. 6 shows there is a large spike in the number of particles between 70 μm and 300 μm in size immediately after HF addition begins and the number of particles in this size range decreases as the reaction progresses. In this example, analysis of the dried product after the reaction showed there were very few LiF particles above 50 μm (Dv90=47.4 μm) and so this size range detected by the probe instead corresponds to the formation of bubbles of CO₂ gas. The difficulty in distinguishing bubble formation from large particles limits the utility of the in situ particle size measurements somewhat but some useful information can still be obtained.

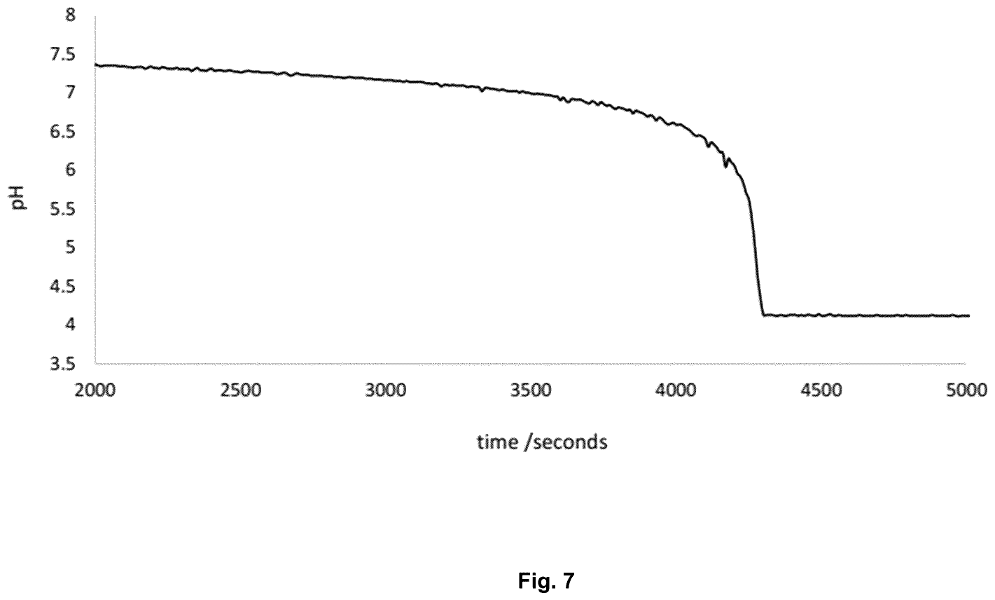

Progress of the reaction was monitored by pH with a calculated endpoint of around 4.5. A typical graph of pH over time is shown in FIG. 7. The graph shows a gradual decrease as LiHCO₃ is increasingly consumed before a rapid decline at the endpoint. Reactions were typically left to stir for 30 minutes after the endpoint, during which time both pH and particle size remained steady.

The resulting slurry was then drained from the reaction vessel and isolated on a Buchner funnel under vacuum filtration. The resulting cake was washed with three bed volumes of deionized water then dried overnight at 105° C. Residual moisture content was determined by TGA and found to be <2% in all cases. Yields were consistently high for experiments using a high concentration of bicarbonate, typically around 75% to 85%. For lower bicarbonate concentrations, the percentage yield decreased as less lithium fluoride was formed and so a greater proportion of the product was dissolved. In addition to in situ particle size data, the particle size of the dried solid product was also measured qualitatively by optical microscopy and quantitatively by laser diffraction using a Malvern Mastersizer 3000 laser diffraction particle size analyzer equipped with Aero S dry dispersion unit (Malvern Panalytical Ltd., Malvern, UK). Samples were also analyzed by helium pycnometry and porosimetry to better characterize the solids. All samples measured had an absolute density of around 2.6 g/cm³, which corresponds well with literature data on the density of LiF. Similarly, porosimetry data showed consistently low surface areas and pore volumes, indicating a lack of porous structure.

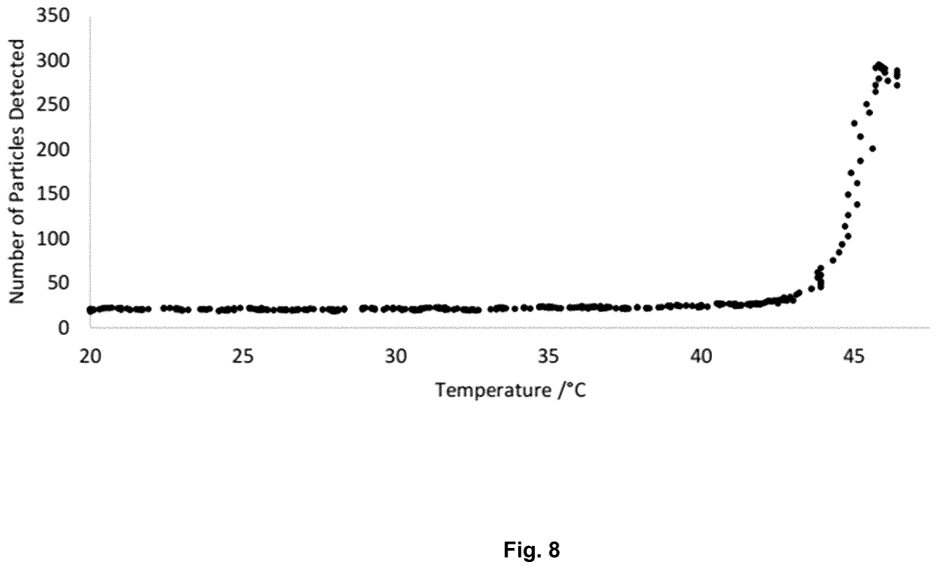

It was discovered that rapid addition of HF to LiHCO₃ led to rapid precipitation of LiHCO₃ and formation of small particles. Lower temperatures (5-15° C.) generally afforded larger particles. However, a higher temperature (45° C.) also gave larger particles. ParticleTrack probe data of 60 g/L bicarbonate was measured up to 50° C. and it was found that Li₂CO₃ begins to precipitate around 35° C., becoming more rapid at 45° C. and above. See FIG. 8.

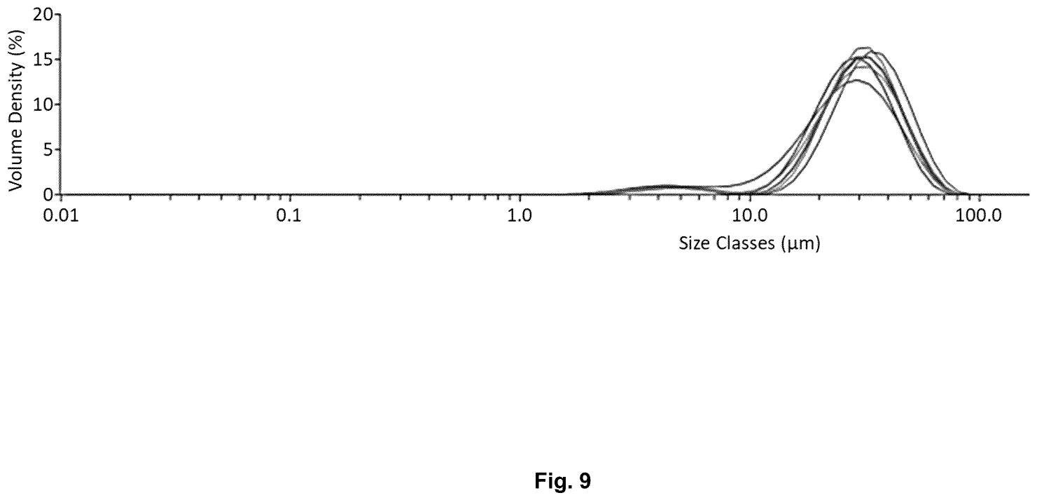

At 60 g/L lithium bicarbonate, it was found that a cubic addition profile where the rate of HF addition increased over the course of the reaction lead to larger particles. But at 40 g/L lithium bicarbonate, there was no improvement in particle size from using a cubic addition profile. At the 40 g/L concentration, a constant addition rate was used throughout each crystallization. Repeat experiments at 40 g/L LiHCO₃ and keeping all other variables constant (5° C. temperature, 400 rpm stirrer speed with anchor impeller at same height, constant 0.1 ml/min addition rate of 40% w/w aq. HF) at 1 L scale showed particles of approximately 30 μm Dv50 results were consistent across eight experimental runs. See FIG. 9.

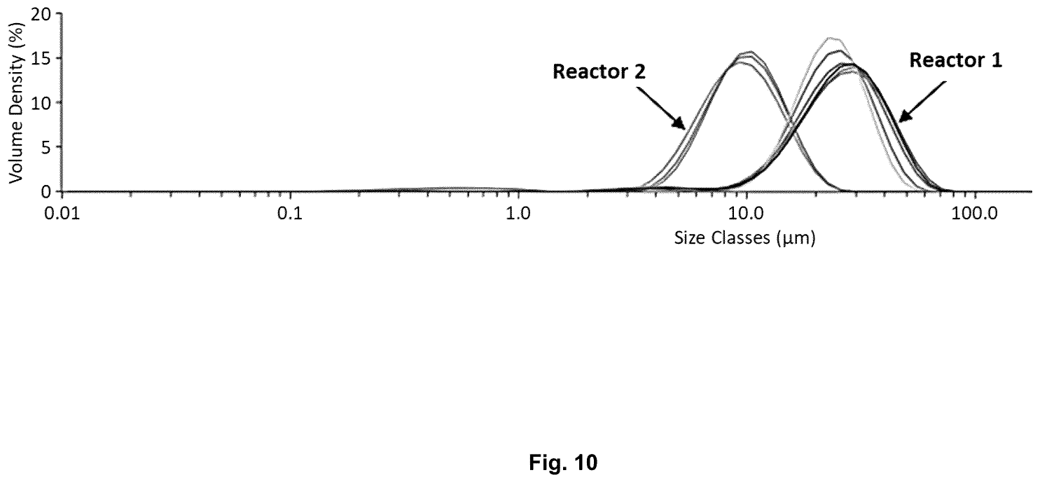

To increase the throughput of the screening reactions, a second 1 L glass Radleys reactor of ostensibly the same design was used in parallel. Repeat reactions in both reactors demonstrated that, under fixed conditions, the particle size of LiF obtained in each reactor is consistent but the particle size from each of the two reactors is significantly different. Under the same conditions, particle size was more than halved between the two reactors. Average Dv50=25 μm for Reactor 1, versus average Dv50=9.5 μm for Reactor 2. See FIG. 10.

Exploration of different possible causative factors for this discrepancy showed that agitation speed, the positioning of the HF feed tube, and the method of washing the reactor between experiments had minimal impact on particle size. However, the height of the anchor-shaped impeller within the vessel was found to be a significant factor. Once both impellers were fixed at the same height, the particle size generated in both reactors became the same. This information prompted an investigation of alternative impellers, beginning with a screw propeller design consisting of four pitched blades to provide more axial flow instead of the solely tangential flow generated by the anchor. However, this offered no beneficial impact on particle size. An impeller with three 15° angled blades gave very similar particle size to the anchor. Finally, a flat impeller with six radial paddles gave significantly lower particle size as did a viscojet impeller, designed to provide highly efficient mixing at low speeds without a significant vortex forming in the reaction vessel. These results suggest that the mixing in the bulk of the reaction mixture is less consequential than the dispersion of HF at the surface of the bicarbonate solution.

To exploit the impact of mixing on particle size, the HF addition point was changed from being above the surface to below. Computation fluid dynamics (CFD) modelling of the reactor vessel suggested a four-blade pitch turbine design would be a preferred configuration. CFD also indicated where it should be placed in the vessel relative to the HF feed tube. These recommendations were implemented in all subsequent experiments.

Most crystallisations were conducted at 5° C. Subsequent repeats demonstrated that the temperature could be increased from 5° C. to 20° C. for reaction with 40 g/L bicarbonate with minimal reduction in particle size. This temperature change also affected an improvement in the morphology of the LiF particles, which appeared more regular and cubic than the agglomerates formed at 5° C. Further increases in temperature above 20° C. led to a larger reduction in particle size. See FIGS. 11A and 11B.

Addition of a tetraalkylammonium chloride surfactant (Aliquat 336, e.g., Starks' catalyst; N-methyl-N,N,N-trioctylammonium chloride) to the crystallization reaction led to an increase in particle size but only to a Dv50 of 38 μm. This compares to reported Dv50 values of over 100 μm using surfactants in a Chinese patent literature. See CN111606336A.

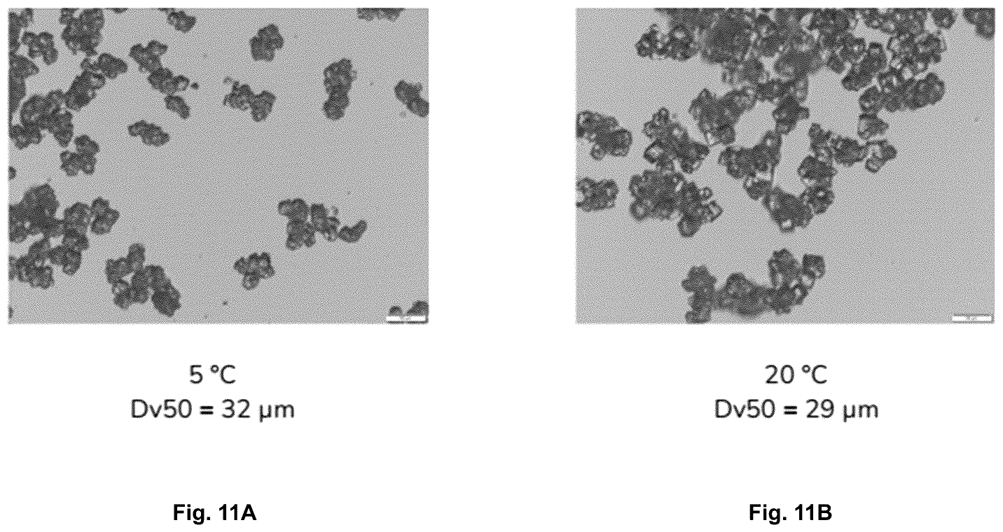

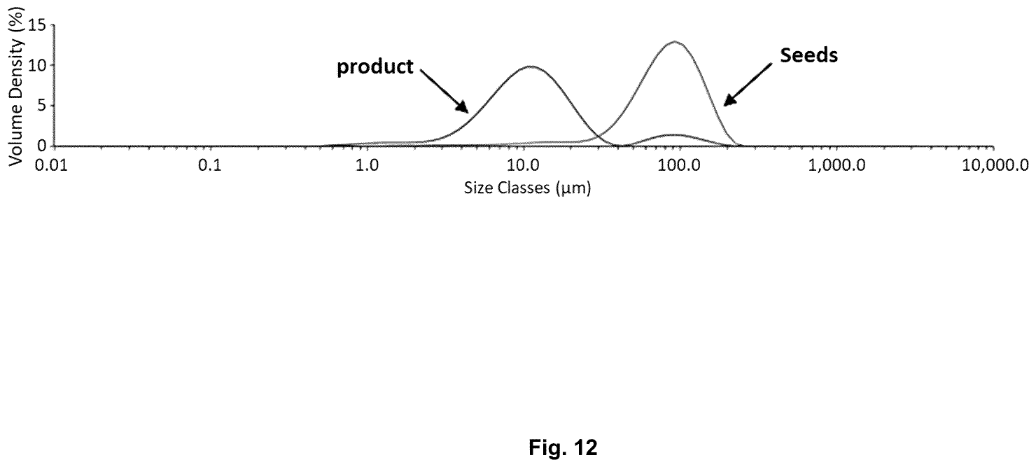

Seeding the crystallization reaction with small LiF particles (Dv50 of 4 μm and up) increases the Dv50. The larger the Dv50 of the seeds added, the larger the particle size became, but not in a linear fashion. The seed size preferably ranges from about 3 μm to about 100 μm. See Table 2. FIG. 12 shows the particle size distribution of the product compared to the seeds used, with the seed crystals still clearly visible at the same size in the product distribution.

TABLE 2
Seeding results based on particle size.

| Seed Crystal Particle Size | Product Particle Size |
|---|---|
| Dv50 (μm) | Dv50 (μm) |
| 4.16 | 20.3 |
| 11.7 | 20.6 |
| 17 | 21.6 |
| 45 | 29.4 |
| 80.4 | 32.7 |

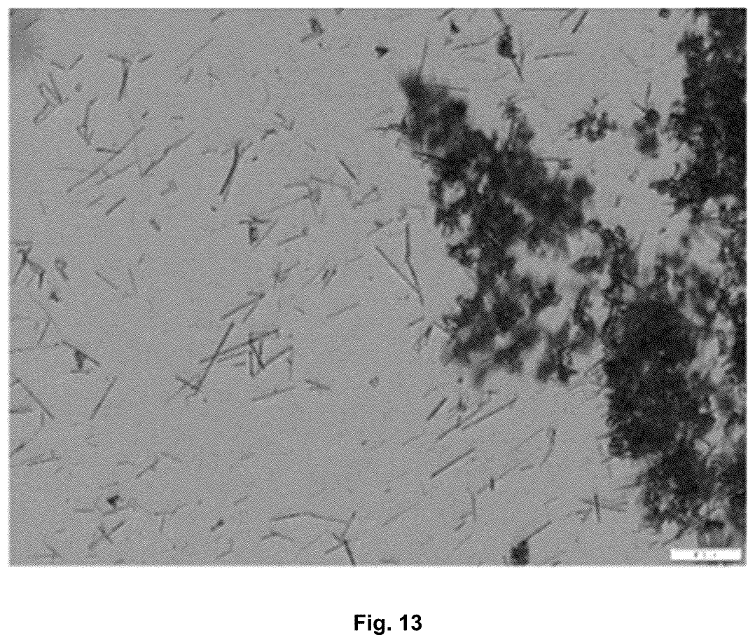

All experiments described thus far added HF to LiHCO₃. The reverse process was also investigated. Because of the very low pH, glass vessels and a pH probe could not be used. These experiments were conducted in a 1 L FEP vessel and monitored manually. The product LiF formed was generally of a very small size, all with a Dv50 of around 10 μm. An interesting difference arose with the reaction of 1% HF by this reverse process, in which the product formed as small needles. See FIG. 13.

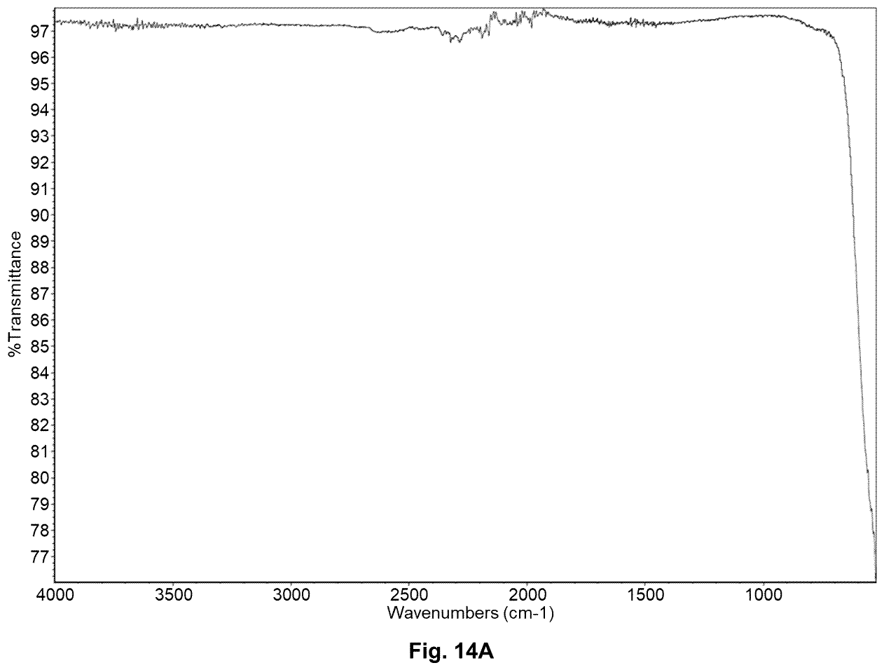

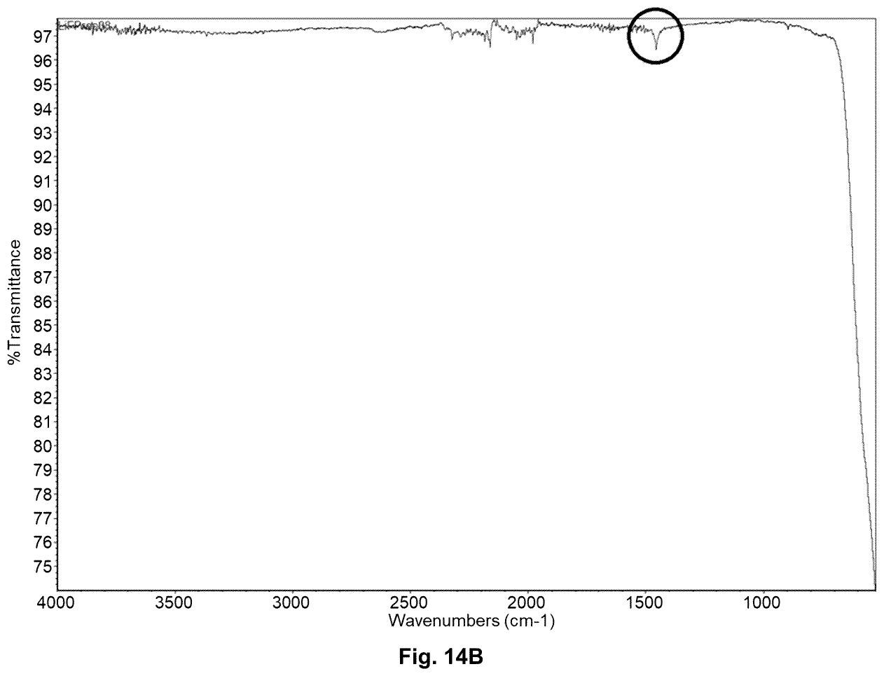

The addition of HF to Li₂CO₃ in water, i.e., skipping the bicarbonation step, was also explored. Li₂CO₃ (9 g/L) was used. This produced very large particles with a Dv50 of 100 μm. The equivalent reaction of 9 g/L LiHCO₃ with HF produced particles of only 70 μm so the increase in size cannot be ascribed entirely to dilution. Reaction of HF with a 20 g/L slurry of Li₂CO₃ not fully dissolved gave much smaller particles with a Dv50 of 15 μm. IR analysis of the LiF formed from this supersaturated reaction also showed the presence of some carbonate in the product. It is believed that LiF formed on the surface of the Li₂CO₃ particles in the slurry, creating a coating that prevented further reaction of the material in the core. However, the large crystals of LiF formed from the clear solution of Li₂CO₃ did not show any sign of carbonate impurities. Sec FIGS. 14A and 14B.

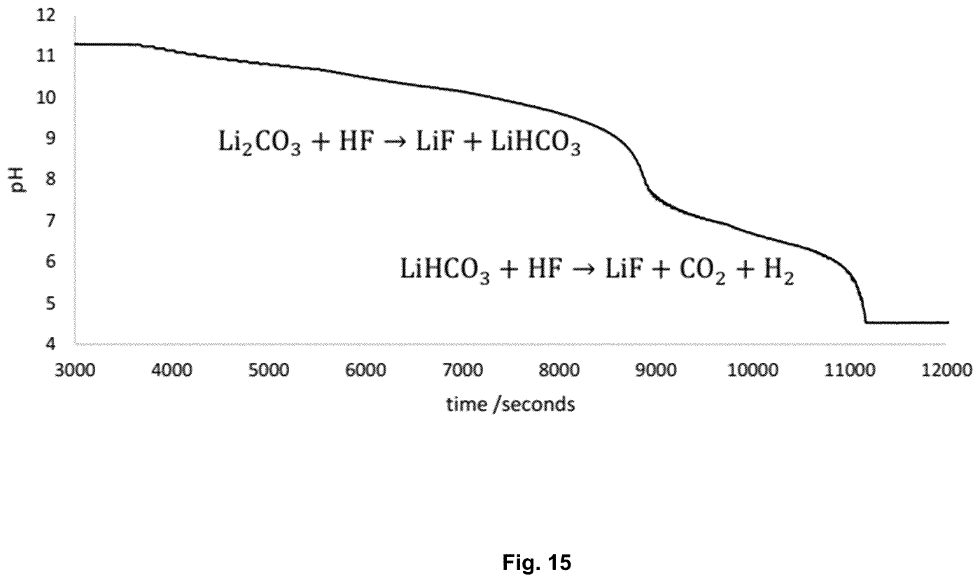

The pH profile for the reaction with Li₂CO₃ shows a different shape to that with LiHCO₃. See FIG. 15. There is no initial increase, suggesting LiF formation alone cannot explain the increase in pH seen in the reaction with LiHCO₃. Rather, pH declines slowly at first then rapidly before the rate decreases again then finally returns to a rapid decline to reach the endpoint. It could be that the first step corresponds to the reaction of HF with Li₂CO₃ to form LiHCO₃ and LiF with the second step then being consumption of this LiHCO₃ generated in situ.

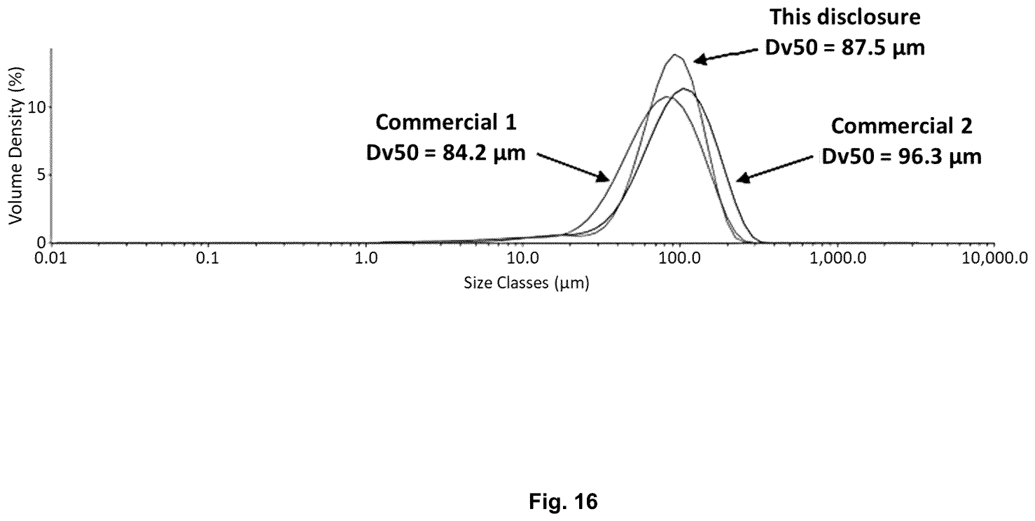

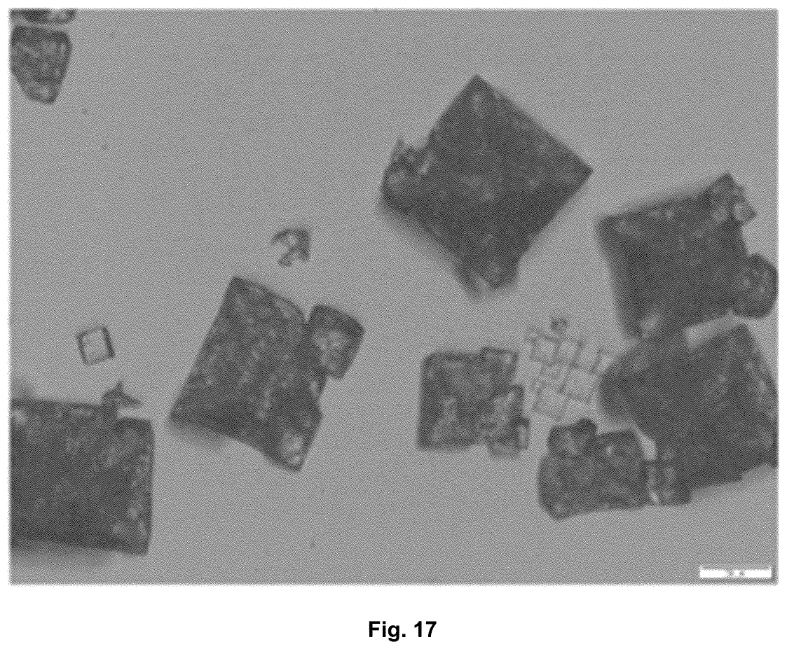

Another approach was developed in which aqueous LiHCO₃ and HF were added at the same time to a stirred reactor filled with water. LiHCO₃ had to be kept in excess to prevent damage to the glass reactor and pH probe. This approach formed much larger and more cubic particles. Adding the two reagents above the surface with an anchor impeller gave single cubic crystals with a Dv50 of 65.6 μm. When the two reagents were added subsurface with a turbine impeller, the Dv50 was increased to 87.5 μm. However, when HF and LiHCO3 were added into LiF-saturated water rather than deionized water, the Dv50 of the resulting LiF dropped to 63.9 μm. Nevertheless, this was a significant improvement in particle size given that the addition time was much more rapid than the previous methodology. To obtain crystals of a similar size, 400 mL of 40 g/L LiHCO₃ typically takes several hours to react when adding HF dropwise to the bicarbonate solution. In contrast, the same particle size can be obtained by this mixed addition method in just 15 minutes with the same volume of reagent. See FIGS. 16 and 17.

### Scalability of the Crystallization of Lithium Fluoride

In an initial attempt at scale-up from 1 L reactions, cubic addition of HF to LiHCO₃ was conducted at a 10 L in a 20 L polypropylene vessel. Here, the LiHCO₃ solution was generated by continuous bicarbonation and the lithium content quantified by IC. On the first attempt, the product formed from this reaction had a slightly smaller particle size as compared to the product realized at the 1 L scale. This was initially attributed to a lack of temperature control of the exotherm generated by adding the HF. The reaction apparatus was redesigned to include a cooling coil attached to an external chiller, allowing the reaction temperature to be controlled to 5° C. This, however, did not lead to any significant change in particle size. After repeated reactions, it was observed that the HF had caused corrosion of the stainless-steel coils. While not being limited to any underlying mechanism or phenomenon, it is thought that the presence of iron in the reaction mixture led to the reduced particle size.

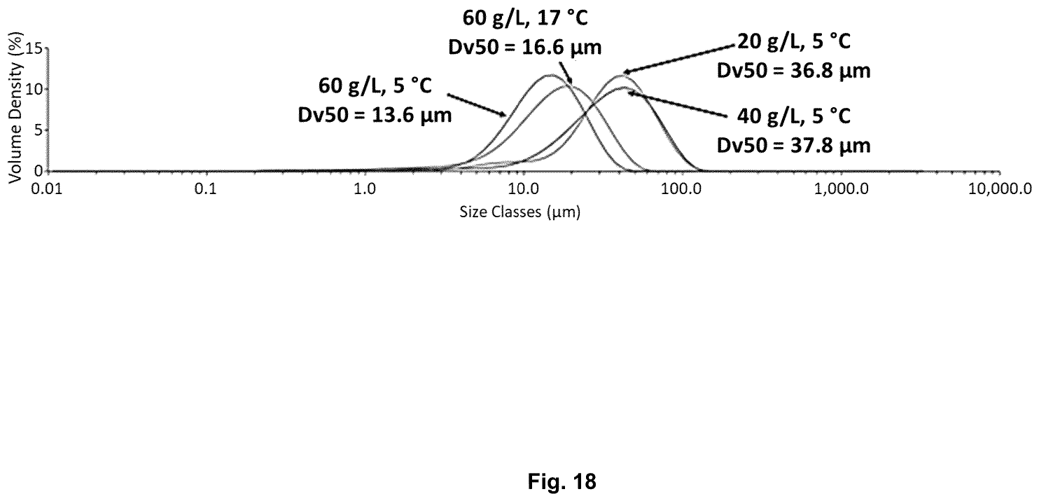

It is also equally probable that the differences in particle sizes between 1 L reactions and 10 L reactions resulted from the different mixing caused by the different shapes of the reactor vessels. Reactions with a range of dilutions were carried out at the 10 L scale and showed the same pattern as at the 1 L scale, with lower LiHCO₃ concentration giving larger particles. (Data not shown.) Repetition of the most promising 1 L conditions (40 g/L bicarbonate at 5° C.) gave more variable particle sizes than had been seen at 1 L:Dv50 (i.e., median particle size by volume) as low as 27 μm and as high as 38 μm across four experiments. See FIG. 18.

Alternative impeller designs were also tested at the 10 L scale. A turbine-shaped impeller did not yield significant improvement. A further alteration was investigated by allowing the HF to run down the side of the vessel rather than dripped directly into the reaction solution (with the aim of improving mixing at the point of contact). This also did not improve particle size. Repetition of the best conditions using the 10 L reactor over 10 experiments afforded >2 kg of LiF particles with an average Dv50 of around 30 μm once combined. The bulk material was found to be a medium flow material. Handling of the bulk powder is thus reasonably straightforward, although not as easy as with conventional commercial LiF, which typically a Dv50 around 70 μm.

As at the 1 L scale, it was found that there was little added benefit from the cubic addition profile when using 40 g/L bicarbonate. Particle size could be further improved by employing a mixed HF concentration approach where the initial feed of HF was at 5% concentration by weight, but the majority of HF added remained at 40 wt %. At the 10 L scale, various sub-surface addition protocols were attempted with the aim of improving the dispersion of HF relative to the dropwise addition of HF onto the surface of the bicarbonate solution used in prior runs. Initially, sub-surface addition of the HF had minimal impact on the size and morphology of the LiF particles formed, increasing Dv50 by an average of only 2 μm. CFD calculations were brought to bear to determine, for the reactor configuration and stirrer used, where was an optimum inlet point for best mixing. Fixing the HF inlet very near the turbine impeller in the position predicted by CFD calculations to give the best mixing, the particle size obtained increased from 21.8 μm to 48.5 μm.

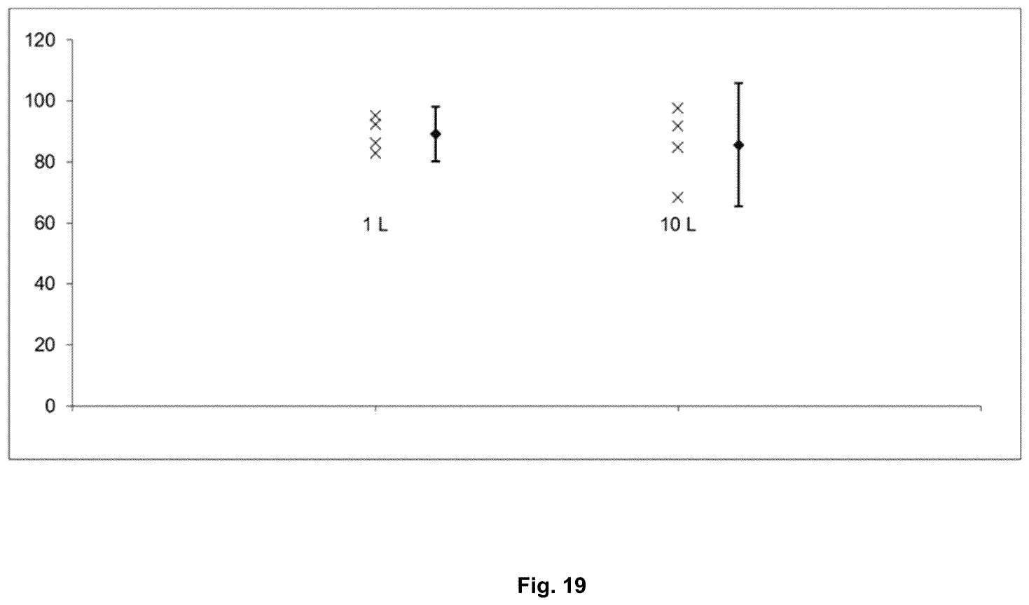

The mixed co-addition method was adopted on 1 L scale to enable preparation of >80 μm LiF particles and then transferred to 10 L. Initially, the particle size obtained was consistently smaller at the 10 L scale. However, the 10 L reactions had longer addition times due to the limitations of pump speed and tubing size. With larger diameter tubing, the addition time could be matched between the two scales and the particle size at both scales became the same. An analysis of particle size obtained showed there was no statistically significant difference in mean Dv50 between 1 L and 10 L nor in the number of fine particles less than 20 μm. While the standard deviation across experiments for Dv50 on the 10 L scale was larger, it was also not significantly different from that at 1 L scale. See FIG. 19.

The crystallization of LiF was then scaled-up to 50 L employing a glass reactor manufactured by Syrris Ltd (Royston, Herts, UK). Two LiHCO₃ feeds were required to enable the reaction to be complete in the same timeframe as at the 1 L and 10 L scales. The particle size obtained in the first LiF crystallisation at 50 L scale was within the range of those produced at smaller scales with a Dv50 of 79.8 μm.

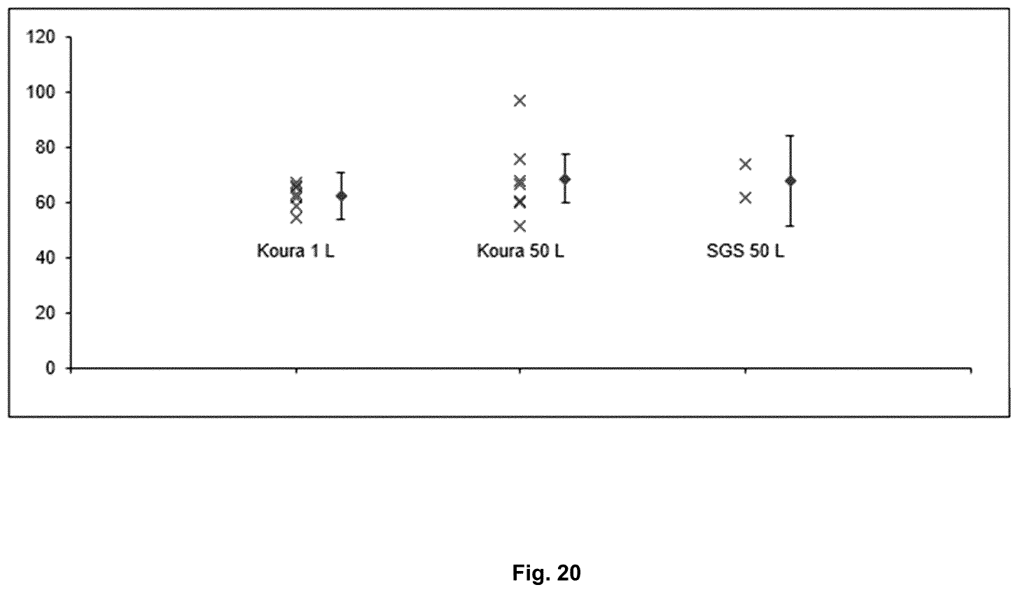

Repetition of the reaction at 50 L scale allowed statistical comparison with the other two scales. However, these produced significantly smaller particles, which (as noted above) was attributed to the effect of iron contamination in the lithium bicarbonate stream. By comparing experiments carried out under the same conditions at 1 L and 50 L scales with similar levels of iron contamination, once again there was no statistically significant difference in the particle size obtained. Further confirmation of scalability was obtained when the same reaction was carried out by an external contract research organization (SGS United Kingdom Ltd., Ellesmere Port, Cheshire, United Kingdom). This demonstrated that the process was not only robustly transferrable between scales but also between operators and sites with differing equipment and ambient conditions. See FIG. 20, which compares the particle sizes obtained at 1 L and 50 L (in house) and at 50 L by SGS.

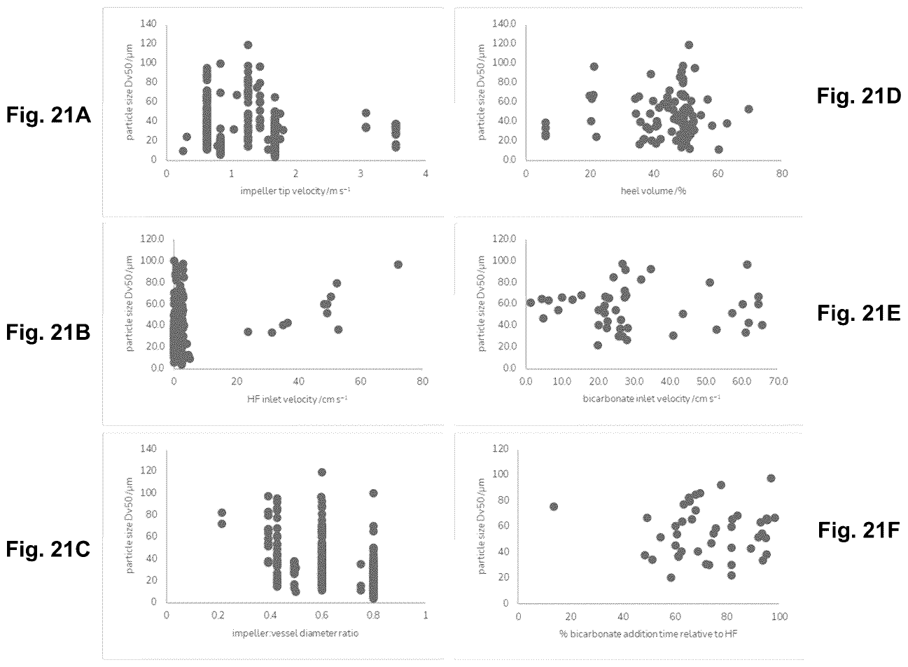

Investigation of the operating parameters, particularly those relating to addition time, showed limited correlations with particle size. The only apparent relationship being an increase in particle size at higher HF addition velocities. This may be attributable to formation of a solid LiF plug at the end of the HF inlet tube at lower velocities. All other variables included in the statistical analysis did not show any significant correlations. As such, the variance in particle size is likely due to another source not accounted for in the graphs shown in FIGS. 21A through 21F. The most likely contender is iron contamination, which was not regularly monitored until late in the experimental program. However, iron concentration can be easily controlled by ion exchange and the use of appropriate materials in the reactor and material-handling equipment. While there could be other unknown variables that have a significant impact on particle size, there is a reasonably wide range over which the operating parameters investigated can be varied while still achieving the target particle size.

As shown here, the crystallization of LiF was scaled-up from 1 L scale to 10 L and then to 50 L, resulting in an increase from 10 s of grams of product per experiment up to kilograms. Once the reaction time was matched between reactors and iron contamination was controlled for, no statistically significant difference in particle size between scales was observed. HF inlet addition velocity appears to be the main contributing factor in explaining why matching reaction times between scales was key to obtaining consistent results. This is a positive indication for scalability from 50 L up to the intended 24 m³-scale for the full-scale commercial process.

### Controlling Other Impurities During Crystallization of Lithium Fluoride

For lithium fluoride to be considered “battery-grade,” it must meet stringent purity requirements. As the most significant impurities in the lithium carbonate feed are calcium and magnesium, an ion exchange step is used to remove these cations. However, when calcium and magnesium are removed by the ion-exchange resin, the ions already on the resin are released into the bicarbonate solution. Typically, the resin is loaded with sodium. In that situation, removing the calcium and magnesium via ion exchange leads to elevated sodium levels in the solution. Therefore, experiments were undertaken to investigate the impact of sodium on LiF particle size and morphology, as well as the effect of different methods of washing on sodium concentrations. Due to the much greater solubility of NaF in water compared to LiF (see Table 3), the initial expectation was that sodium impurities could be removed by washing the solid product.

TABLE 3
Solubilities of various fluoride salts.

| Compound | Solubility at 20° C./g L⁻¹ |
|---|---|
| LiF | 1.27 |
| NaF | 40.4 |
| MgF₂ | 0.13 |
| CaF₂ | 0.016 |

Battery-grade LiF is conventionally obtained by first carrying out the ion-exchange process on the lithium bicarbonate solution followed by a decomposition step to form purer lithium carbonate solid (and leaving the sodium from the ion exchange in solution). This purified solid then undergoes a second bicarbonation to form a solution of lithium bicarbonate with low levels of sodium, magnesium, and calcium for use in the LiF crystallization. As noted above, chelating agents, such as ethylenediamine tetraacetate (EDTA) may also be used to complex magnesium, calcium, and other heavier metals, thus removing the need for an ion-exchange process. The magnesium and calcium complexes are water soluble and removed by washing. However, additional steps are then needed to either remove the EDTA by pyrolysis or to regenerate the free EDTA for recycling. If a second bicarbonation step is omitted, there is a need to remove sodium at some other point in the process as the ion exchange will introduce additional sodium into the system. If the process water is recycled (which is desirable), the concentration of sodium will rise as more sodium accumulates with successive recycling of the water.

For all the following examples, LiF was formed by reacting HF with LiHCO₃. The bicarbonate was generated from commercially sourced lithium carbonate (Orocobre “Micronised”-grade Li₂CO₃ (now Allkem Ltd., Brisbane, Australia)). The specifications provided for the “Micronized”-grade Li₂CO₃ have the same impurity profile as the “Pure”-grade, Li₂CO₃, the only difference being particle size. Inductively-coupled plasma mass spectrometry (ICP-MS) analysis, carried out externally by Lucideon (Stoke-on-Trent, UK), was used to determine the levels of sodium, magnesium, and calcium in several LiF samples, as well as the Li₂CO₃ starting material. This testing indicated that the batch of Li₂CO₃ received from Allkem was two orders of magnitude purer than the limits given in their specification. See Table 4.

TABLE 4
Impurity profile in commercial lithium carbonate (Spec vs. Actual)

| LiF Prep Number | [Na]/ppm | [Mg]/ppm | [Ca]/ppm |
|---|---|---|---|
| Starting Material | 500 | 100 | 200 |
| (specification) | | | |
| Starting Material | 5 | 3 | 4 |
| (actual) | | | |
| 141 | 26 | 2 | 12 |
| 151 | 10 | 2 | 15 |
| 171 | 2 | 3 | 8 |
| 185 | <2 | 5 | 12 |
| 188 | <2 | 6 | 10 |
| 196 | <2 | 3 | 5 |

For LiF preparations using bicarbonate derived from the micronized Li₂CO₃, the levels of impurities in product are generally low, but elevated with respect to calcium (i.e., calcium-to-lithium). This is in part due to the transformation from a species with two lithium ions (Li₂CO₃) to just one in the product (LiF) and so an increase of approximately 33% would be expected in all circumstances just through stoichiometry. Analysis of the water used in the reaction showed less than 1 ppm of calcium and the supplier's certificate of analysis for the batch of HF used had similar levels. Therefore, no extra calcium is being introduced. The enrichment of the product in calcium is likely due to the very low aqueous solubility of CaF₂, meaning that it was left behind during the washing process. Nevertheless, even without ion exchange being used, all samples tested were within or near specification limits for these three key impurities.

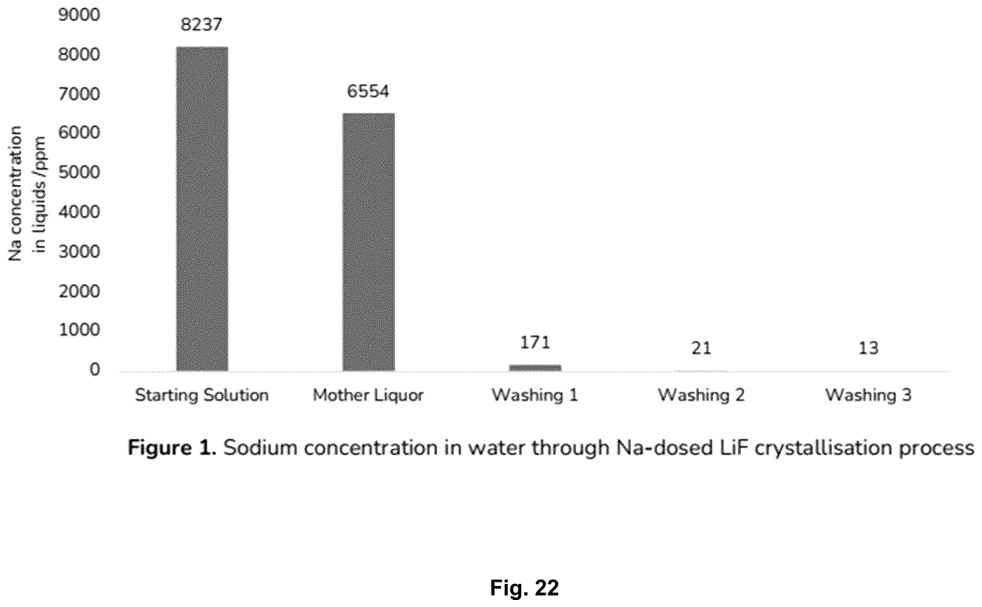

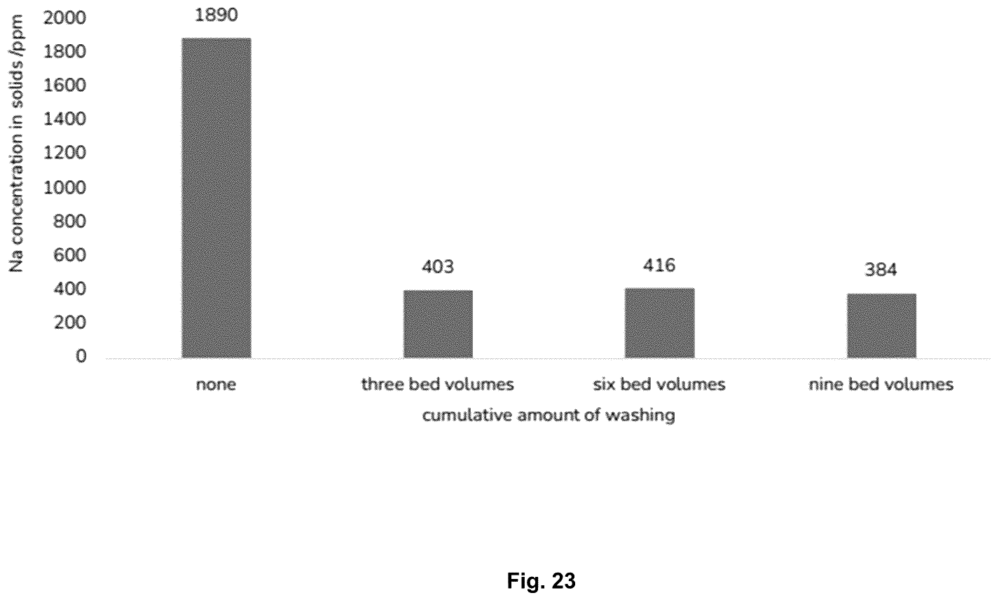

To simulate the effect of additional sodium being introduced by an ion-exchange process, NaHCO₃ was added to the LiHCO₃ solution before reaction with HF. Ion chromatography (IC) and ICP-MS analysis were used to determine the fate of the sodium. IC is suitable for the analysis of liquids but not for solids as LiF has very low aqueous solubility. Attempts at acid digestion of LiF led to elevated levels of sodium being measured by IC analysis due to the much greater solubility of NaF compared to LiF. Therefore, ICP-MS analysis had to be used for determining impurity content in solids. The amount of sodium in solution was determined by IC (before the crystallization) in the mother liquor following filtration of the solids, and in the water from each subsequent washing. This showed that most of the sodium remains in solution but a significant amount remains behind and is not removed by further washing with water. Each washing step consists of three bed volumes of deionized water. The results are shown in FIG. 22. ICP-MS analysis of the solids after each washing step showed the same pattern, with significant amounts of sodium removed by the first three bed volumes but then plateauing. The elevated levels of magnesium and calcium can be attributed to impurities arising from the NaHCO₃ used for dosing. However, calcium levels increased with further washings due to the low aqueous solubility of CaF₂ as discussed above. A similar, albeit smaller, increase in magnesium levels occurs due to the low solubility of MgF₂, which is more soluble than CaF₂ and so the increase is not as large. See Table 5 and FIG. 23.

TABLE 5
Impurity profile in LiF after washes.

| Total washes | [Na]/ppm | [Mg]/ppm | [Ca]/ppm |
|---|---|---|---|
| none | 1890 | 17 | 85 |
| three bed volumes | 403 | 23 | 98 |
| six bed volumes | 416 | 22 | 130 |
| nine bed volumes | 384 | 23 | 127 |

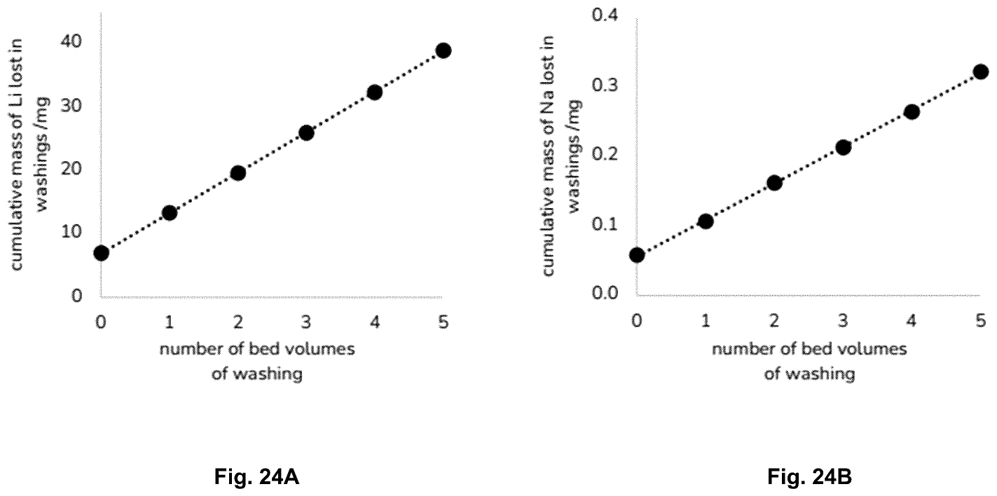

Furthermore, with each subsequent washing step, more lithium is dissolved in the wash water and so the yield of product is reduced. While calcium and magnesium were at too low a concentration to be observed by IC, sodium could be seen and followed the same linear pattern as Li. Therefore, further sodium removal by further washings may be possible but only at the cost of additional lithium fluoride being dissolved. See FIGS. 24A and 24B.

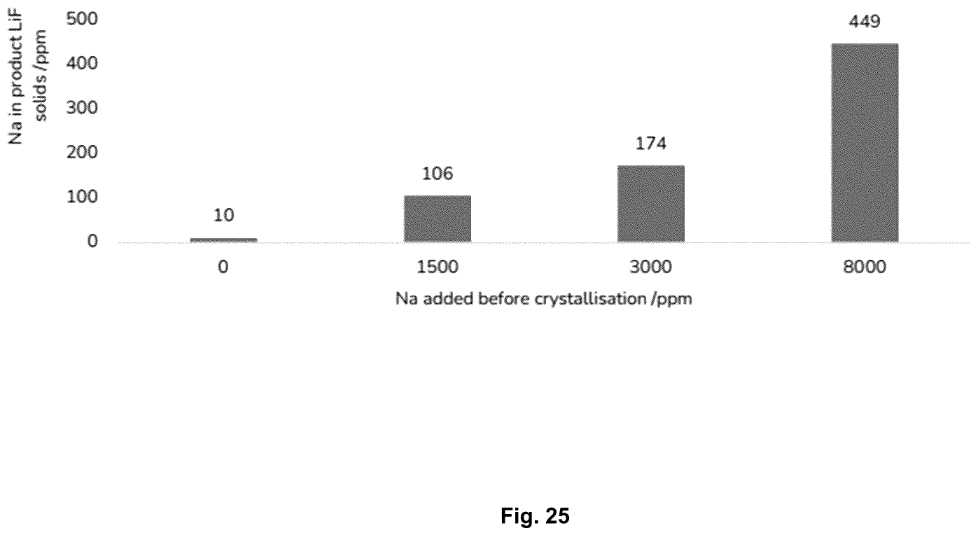

With different levels of sodium in the initial feed, ICP-MS analysis showed different amounts of sodium are present in the final product. However, even at the lowest levels tried (500 ppm), the concentration of sodium in the LiF product is still well above specification. Different styles of washing were also attempted but, with 1000 ppm of sodium in the feed, repulping and plug flow washing removed only 17 ppm and 23 ppm of sodium, respectively. While plug flow is better able to remove sodium, this change was insufficient to reduce sodium to acceptable levels in the LiF solids. Therefore, sodium levels in the water must be kept to a minimum if using this washing process. To mitigate the effect, the ion exchange resin can be charged with LiOH, rather than NaOH, to avoid introducing additional sodium. See FIG. 25.

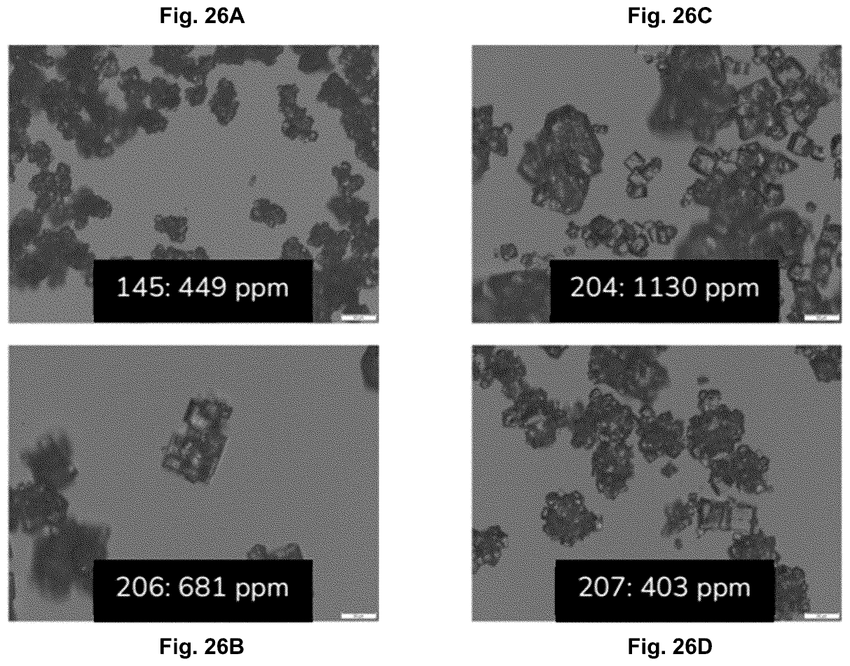

The effect of morphology on sodium levels was also explored. It appears that the larger and more cubic particles contained higher levels of impurity than the smaller agglomerates. This suggests that there is a significant amount of sodium contained inside the crystal that cannot be removed by washing. As these larger crystals have a smaller surface area: volume ratio, more sodium is trapped inside the crystals and so less can be removed simply by washing. See Table 6 and FIGS. 26A, 26B, 26C, and 26D.

TABLE 6
Impurity profile of LiF having different morphology.

| LiF Prep | Dv50/μm | [Na]/ppm | [Mg]/ppm | [Ca]/ppm |
|---|---|---|---|---|
| 145 | 31.4 | 449 | 18 | 92 |
| 204 | 71.2 | 1130 | 14 | 92 |
| 206 | 69.8 | 681 | 30 | 131 |
| 207 | 60.0 | 403 | 23 | 98 |

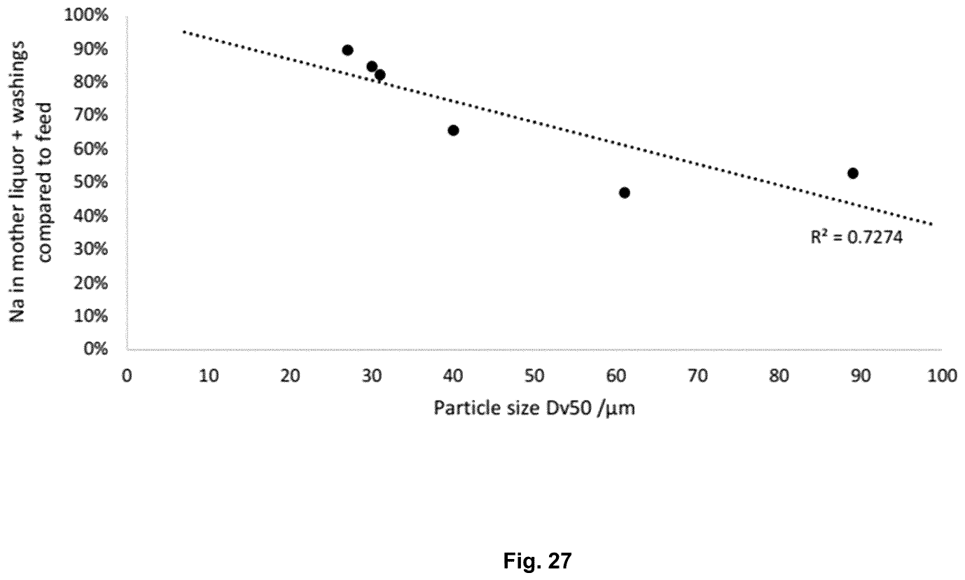

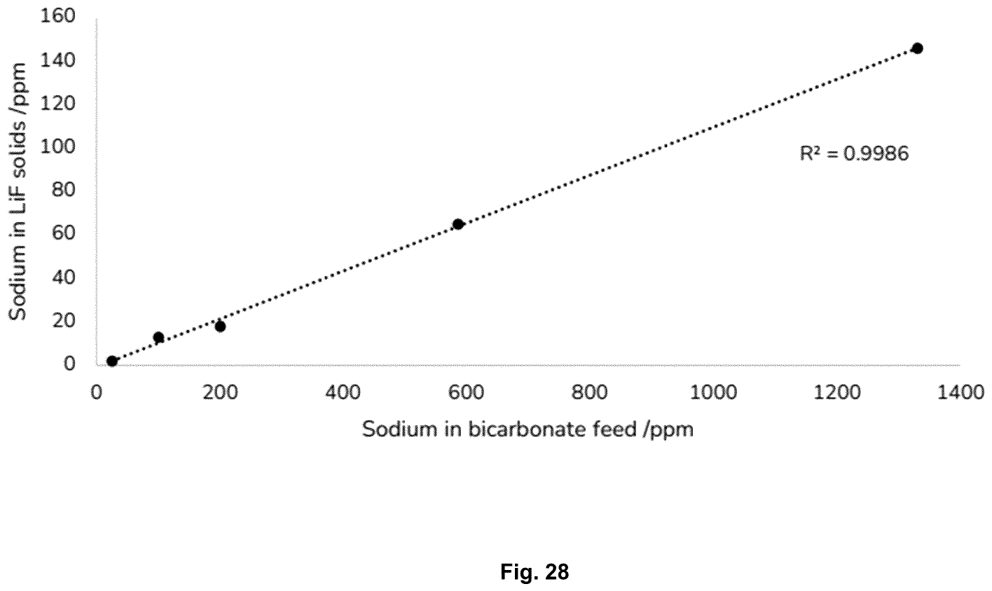

By comparing the concentration of sodium dosed into feed to the combined concentration of sodium in the mother liquor and wash water, the difference between the two should equal the amount of sodium trapped in the solids. Carrying out this analysis for all sodium-dosed experiments and plotting the result against particle size showed some negative correlation, i.e. the larger the LiF particles, the more sodium is retained by the solids. This lends further evidence to the theory that sodium is trapped inside the crystals and cannot be removed by washing, regardless of washing method. See FIG. 27.

It had become clear that only low levels of sodium in the recycle water were tolerable to achieve low levels of sodium in the final product LiF. Therefore, the crystallization was carried out using much lower levels of sodium dosing to determine the effect on sodium inclusion in the product. NaF was also used for the dosing rather than NaHCO₃ as previously to better simulate the intended recycle process. However, the aqueous solubility of NaF (40.4 g/L) is less than half that of NaHCO₃ (96 g/L). Although it appeared all NaF had dissolved, some particles may have remained suspended and so the level of sodium measured in the product would have been elevated due to the presence of solid NaF that had been carried through the process. The data from NaHCO₃ dosing is likely more representative of the final process as all Na⁺ is in solution. Sodium levels in the final product were an order of magnitude lower than in the feed. See Table 7.

TABLE 7
Sodium levels in bicarbonate feed and corresponding
LiF product with different sodium sources.

| | Target [Na] in | Measured [Na] | [Na] in |
|---|---|---|---|
| Na source | bicarb feed/ppm | in bicarb feed/ppm | product/ppm |
| NaHCO₃ | 1000 | 1330 | 146 |
| NaHCO₃ | 500 | 586 | 65 |
| NaF | 1000 | 1250 | 1579 |
| NaF | 125 | 496 | 198 |
| none | 0 | 25 | 2 |

To confirm these findings, further experiments were conducted with 100 ppm and 200 ppm sodium fluoride at both 1 L and 50 L scale with different operators to minimize any potential human errors. This confirmed that an average of 10% of the sodium in solution is transferred to the solid LiF. See Table 8.

TABLE 8
Impurity profile of LiF product following sodium fluoride dosing.

| [Na] in bicarb | [Na] in | [Mg] in | [Ca] in |
|---|---|---|---|
| feed/ppm | product/ppm | product/ppm | product/ppm |
| 100 | 13 | 5 | 9 |
| 200 | 18 | 4 | 7 |

These lower-level dosing results using NaHCO₃ combined show a strong linear correlation. Therefore, if the specification for sodium in LiF were set at 20 ppm, which would be comparable to other commercial suppliers of battery-grade LiF, the sodium concentration in the bicarbonate feed would need to be kept below 200 ppm. This would inform how regularly the recycle water needs to be purged from the system (to avoid an unacceptable build-up of sodium). See FIG. 28.

Semi-quantitative ICP-OES (optical emission spectroscopy) analysis was also carried out on LiF from a crystallization not dosed with sodium to determine if any trace impurities were present beyond sodium, magnesium, and calcium. The largest impurity was silicon, at 17 ppm, which is likely to come from SiF₆ in the hydrofluoric acid or from etching of the glass reactor. Etching is not a concern for the full-scale process because it uses plastic-lined steel vessels. The certificate of analysis for the batch of HF used in this crystallization of LiF only quantified SiF₆ levels as being less than 50 ppm. See Table 9.

TABLE 9
Impurity profile of LiF product without sodium dosing.

| Element | Concentration in LiF/ppm |
|---|---|
| Al | 1.5 |
| As | <3 |
| Ba | 0.8 |
| Ca | 7.4 |
| Fe | 3.0 |
| K | 3.8 |
| Mg | 2.8 |
| Na | 1.0 |
| Nb | 0.1 |
| Nd | 0.1 |
| Ni | 0.6 |
| P | 9.1 |
| S | 1.1 |
| Si | 17 |
| Sr | 1.1 |
| Ti | 0.1 |
| Zn | 4.0 |
| Zr | 0.1 |

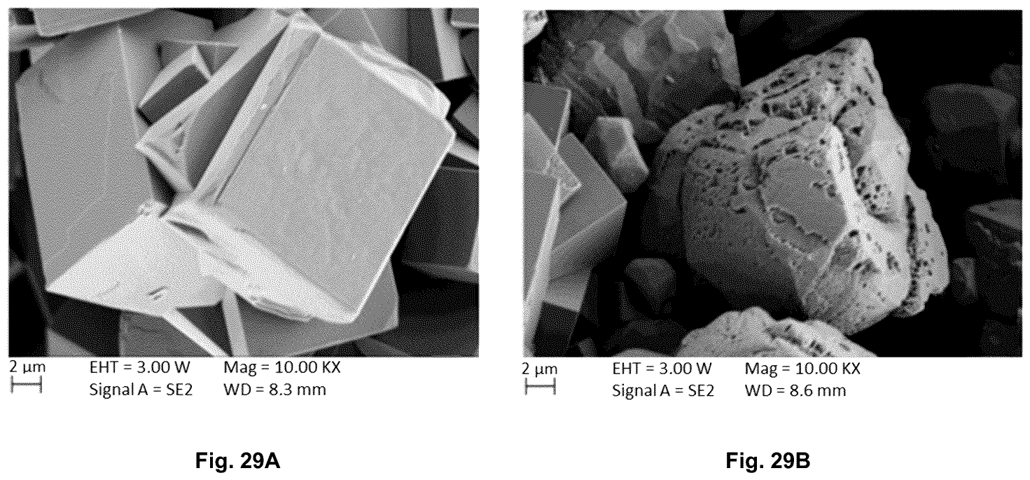

Infrared spectroscopic analysis of the LiF formed by these reactions showed no absorbances that would indicate the presence of carbonate contamination. However, when an alternative qualitative test using phenolphthalein was used, carbonate was found in some samples as proven by the indicator turning pink and thus showing the presence of a basic compound. LiF particles with a more cubic morphology passed this test whereas those with more irregular agglomerates failed. This is believed to be due to carbonate becoming trapped on the surface of the LiF crystals as they form, in small enough quantities that it was not detectable by IR but sufficient to render the powder unsuitable for the subsequent reaction to form LiPF₆. See FIGS. 29A and 29B.

In sum, the crystallization process we have developed consistently produces LiF with all impurities within specification limits. When using battery-grade purity Li₂CO₃, the product LiF obtained is within specification for sodium, magnesium, and calcium. With the current methodology, the levels of sodium should not exceed about 200 ppm in the recycle water. Using LiOH to regenerate the ion exchange resin prevents any additional sodium from entering the system. Despite the increased cost of LiOH compared to NaOH, this change does not significantly increase variable cost: Removing the largest source of sodium greatly reduces the purge rate needed for the recycle water and so offsets the higher price of LiOH compared to NaOH because all lithium introduced into the system is ultimately converted into LiF. (The alternative is additional wash cycles, which will remove the sodium but will also remove significant amounts of lithium from the reaction.)

### Impact of Corrosion on the Crystallization of Lithium Fluoride

To yield commercially suitable LiPF₆ for batteries, it is believed that the LiF crystals used as a reactant should have a particle size of around 80 μm. As noted above, LiF is formed by reacting aqueous hydrogen fluoride and lithium bicarbonate. However, when using highly corrosive reagents such as HF or HF (aq), corrosion is a serious problem that adversely impacts product quality. Thus, methods are needed to mitigate against contamination of the product due the corrosive action of HF on the processing equipment.

The lithium bicarbonate itself is formed by reacting lithium carbonate and carbon dioxide. The key chemical reactions are outlined below:

Li₂CO₃+CO₂+H₂O→2LiHCO₃

LiHCO₃+HF→LiF+CO₂+H₂O

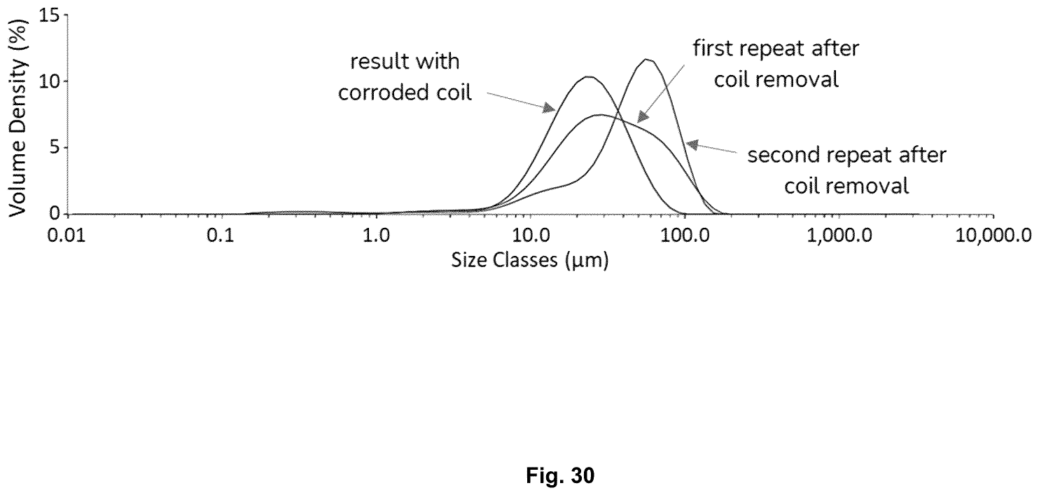

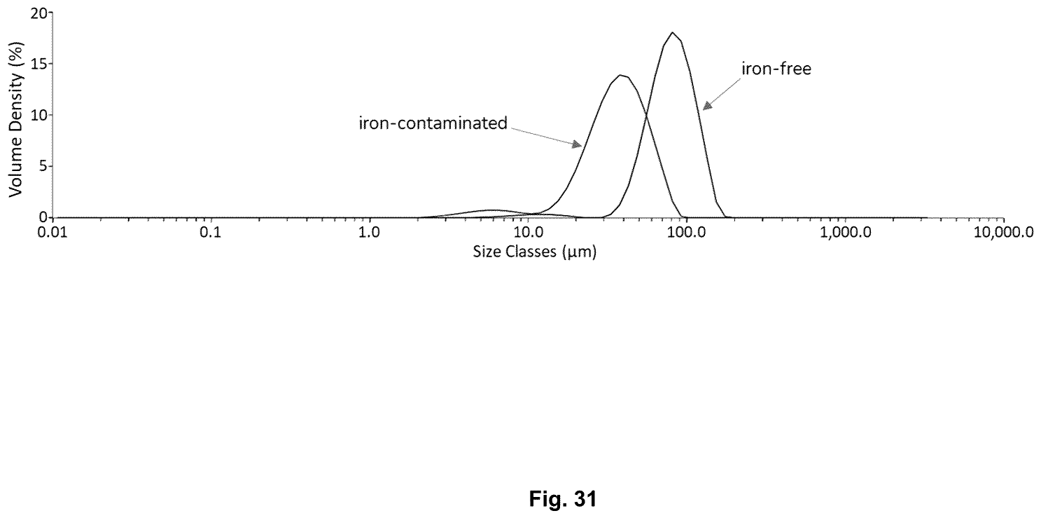

It became apparent during initial experimentation that corrosion in the stainless-steel equipment that contacted either the crystallization reaction mixture or the lithium bicarbonate solution led to a reduction in particle size. Corrosion was first observed as an issue in reactions on the 10 L scale, in which the crystallization reaction took place in a plastic vessel fitted with a stainless-steel cooling coil for temperature control. In the last run before visible corrosion was noticed on the coil, the Dv50 of the LiF particles obtained with the cooling coil present was 22.4 μm. Under identical conditions, this rose to 31.4 μm when the coils were removed, and then to 49.3 μm in a subsequent repeat. This was attributed to the presence of iron in the solution. The working assumption was that after two repeats without the coils, all the remaining contaminants from the corrosion had been flushed from the reactor. See FIG. 30, which shows the particle size of the LiF resulting from the last run with the cooling coil and the two subsequent runs without the cooling coil.

The issue of iron contamination became salient again when, during efforts to model recycling on plant scale, the filtrate from LiF crystallization reactions was used as water in the bicarbonation process. This filtrate is an aqueous solution comprising HF at an average pH of 4.5, the calculated endpoint of the LiF synthesis. This pH corresponds to an HF concentration of approximately 3×10⁻⁵ M. This was not believed to be problematic in terms of compatibility for the bicarbonation reactor, which was constructed principally from stainless steel 316 and perfluoroalkoxy (PFA) plastic tubing. However, with repeated bicarbonation experiments, visible corrosion was eventually observed on the mixer in the slurrying feed vessel for the rig. The materials of construction for this mixer were not known but the rapid corrosion suggested a lower grade of steel.

The runs were repeated using a reactor fitted with a stirrer having a PTFE-coated impeller. When older lots of lithium bicarbonate were used (before corrosion had taken place in the reactor), the Dv50 of the resulting LiF was 79.8 μm. When newer lots of lithium bicarbonate were used (after corrosion had taken place in the reactor) the Dv50 of the resulting LiF was nearly halved to 36.5 μm. See FIG. 31.

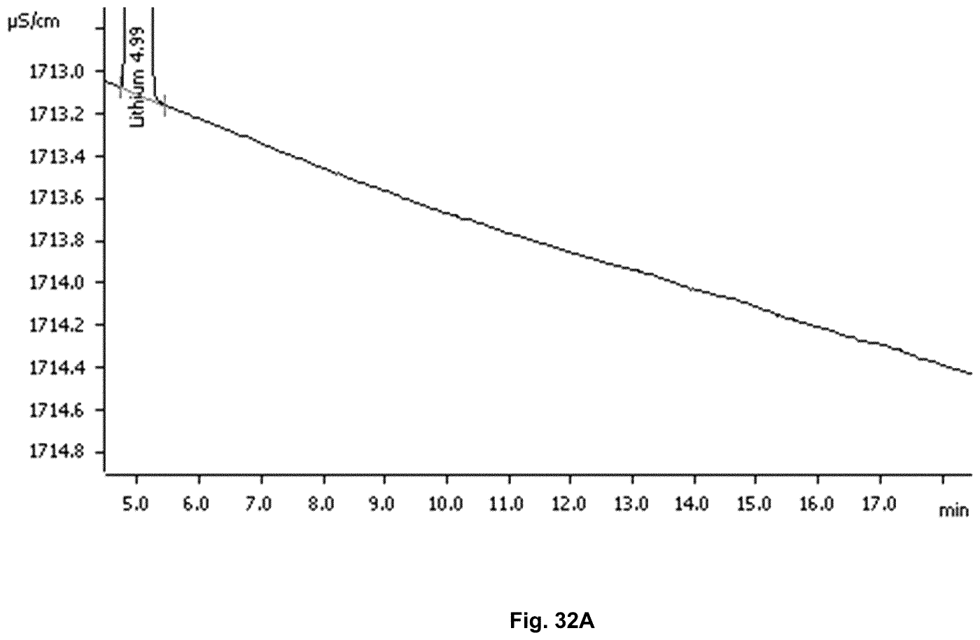

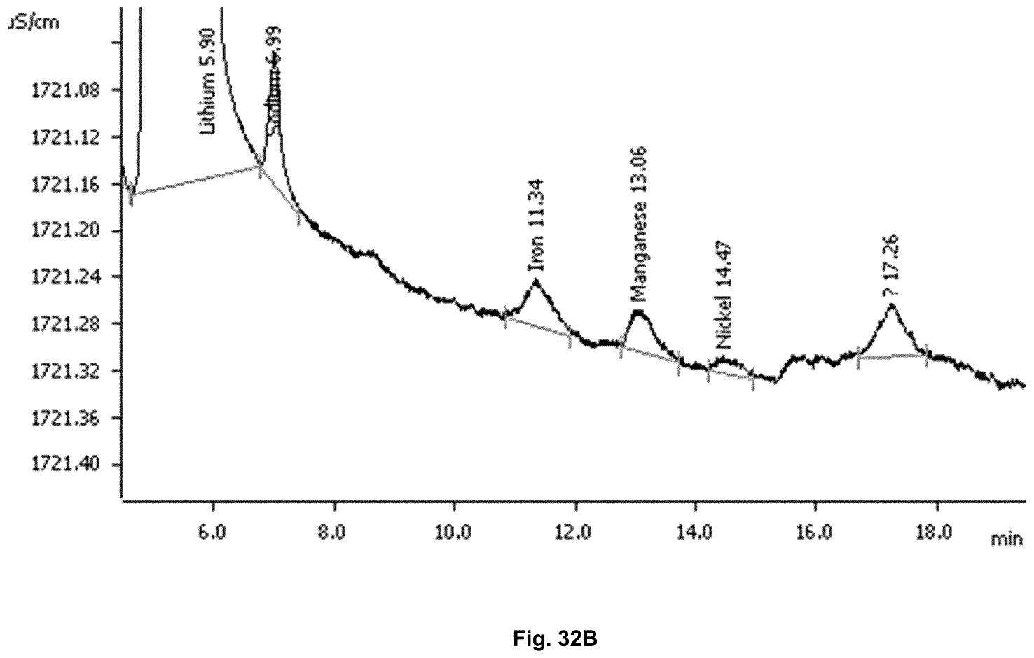

It was not possible to measure iron concentration accurately due to a lack of analytical standards. Nevertheless, using ion chromatography, iron could be qualitatively observed, as well as other elements found in stainless steel 316, such as nickel, manganese, and chromium. Water added to the slurrying feed vessel was found to be devoid of any cations other than residual lithium. But water that had passed through the bicarbonation reactor had picked up several different species in single-digit ppm levels. See FIGS. 32A and 32B. FIG. 32A shows cations present in the reactor water prior to the water being passed through the bicarbonation reactor. FIG. 32B shows cations present in the same reactor water after it had passed through the bicarbonation reactor.

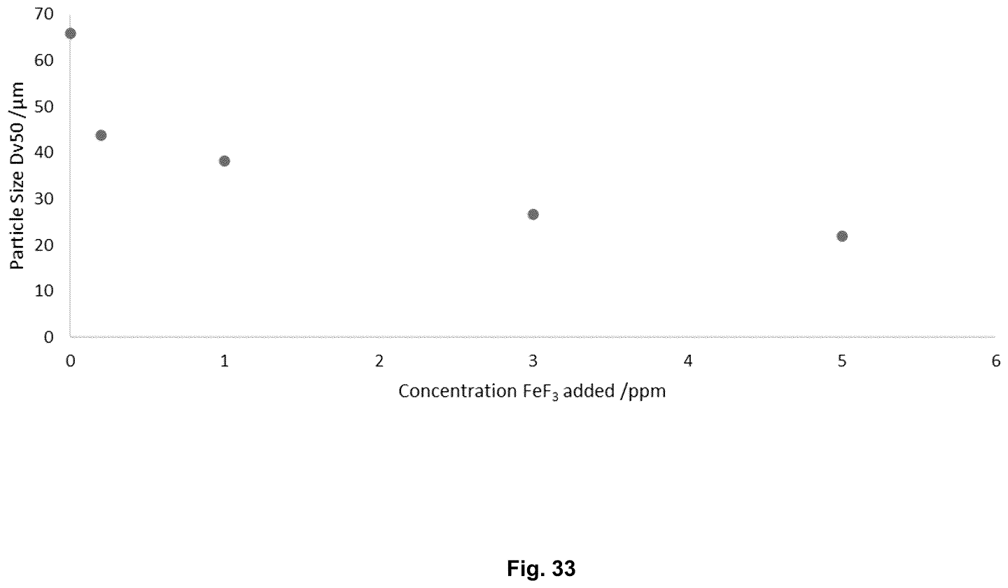

Given the significance of the iron contamination problem, further studies were conducted on 1 L scale to ascertain the nature of the relationship between iron concentration and particle size more precisely. In the usual synthetic procedure, HF and LiHCO₃ were added at the same time into LiF-saturated water. LiF precipitates rapidly. Addition continues until all the bicarbonate is consumed. The pH then drops to the calculated endpoint of 4.5, with HF addition automatically cut-off by the reaction controller software. Iron-dosing experiments were carried out where HF and LiHCO₃ were added not into LiF-saturated water but into deionized water spiked with FeF₃, with all other parameters kept the same. The results from these experiments show that iron concentrations as low as 0.2 ppm have a negative effect on LiF particle size and that the effect is concentration dependent. See FIG. 33, which is a graph showing the Dv50 of the LiF versus FeF₃ concentration.

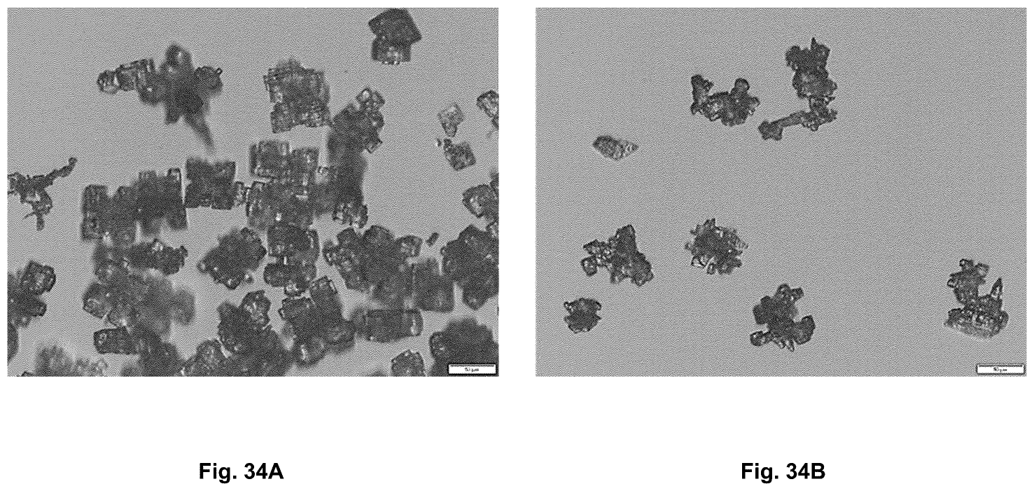

The morphology of the LiF particles was also impacted, with 0.2 ppm Fe still producing single cubes as seen in previous experiments without iron dosing whereas 1 ppm Fe and above yielded smaller, more irregular particles. See FIGS. 34A (0.2 ppm Fe) and 34B (1.0 ppm Fe).

Oxalic acid, EDTA, or both are conventionally used to purify LiHCO₃ before making LiF. Therefore, attempts were made to sequester the iron and thereby prevent the crystal growth-poisoning effect. In a first run, a large excess of citric acid was used as a chelating agent. This led to the formation of a slurry that was very slow to filter and yielded an intractable gelatinous mixture. Repeating the reaction with 1 ppm FeF₃ and 1 ppm citric acid gave LiF having a Dv50 of only 30.3 μm, significantly lower than the 1 ppm Fe alone (Dv50=38.2 μm. However, 1 ppm FeF₃ and 1 ppm oxalic acid yielded LiF with a Dv50 Of 66.0 μm, the same particle size as without any added iron (65.8 μm). Thus oxalate greatly mitigates (or even completely negates) the effect of iron, whereas citrate makes the effect worse. When 1 ppm oxalic acid was added to a reaction without additional iron dosing, the result was a slight increase in Dv50 to 72.5 μm. This result suggests either there is iron present from unknown sources or that oxalic acid has some beneficial effect on the crystallization process beyond chelating heavy metals.

It was observed during the reactions that the solution began as pale green, containing FeF₃, but became a strong yellow-orange color once lithium bicarbonate was added. This suggests reduction of the iron to Fe²⁺. By the end of the reaction, at pH 4.5, the color had largely disappeared and so the iron had likely converted back to Fe³⁺. In the experiments spiked with citric and oxalic acid, the color change was still observed in the presence of citrate but was less clear with oxalate. Iron is known to form a ferrioxalate complex, [Fe(C₂O₄)₃]³⁻, in which the iron center is fully chelated, whereas iron citrate complexes of either Fe²⁺ or Fe³⁺ oxidation state contain labile water ligands. These could be displaced by fluoride or otherwise allowed the iron to engage in different redox chemistries more easily.

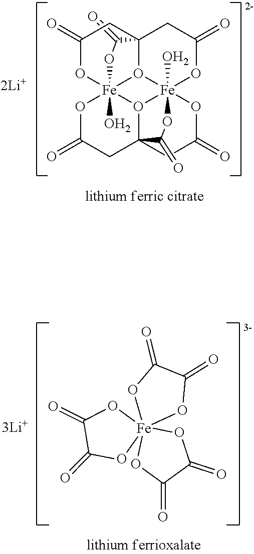

The bicarbonation reactions were also run batch-wise (rather than continuously). While significantly less time efficient, running the reaction batch-wise allowed the removal of almost all stainless steel apparatus from the procedure save for the sintered injection nozzle for the CO₂. To prevent any corrosion from this, LiF was added to deionized water to simulate the recycle process (rather than reusing filtrate from previous experiments). By using this technique to generate the bicarbonate and replacing contaminated tubing, the particle size from LiF made at 1 L scale rose from 30.5 μm to 67.1 μm.

These results show that there is a strong negative correlation between iron concentration in solution and LiF particle size. Chelation of iron was able to completely mitigate this effect with some ligands (oxalic acid) but not with others (citric acid). The specification for iron in Li₂CO₃ from many commercial suppliers is 3 ppm. As shown here, negative effects on LiF particle size were observed as low as 0.2 ppm Fe. Thus, purification of the Li₂CO₃ prior to the reaction to form LiF is required to achieve the desired particle size of the LiF product.

### Removal of Aluminum from Lithium Bicarbonate by Filtration

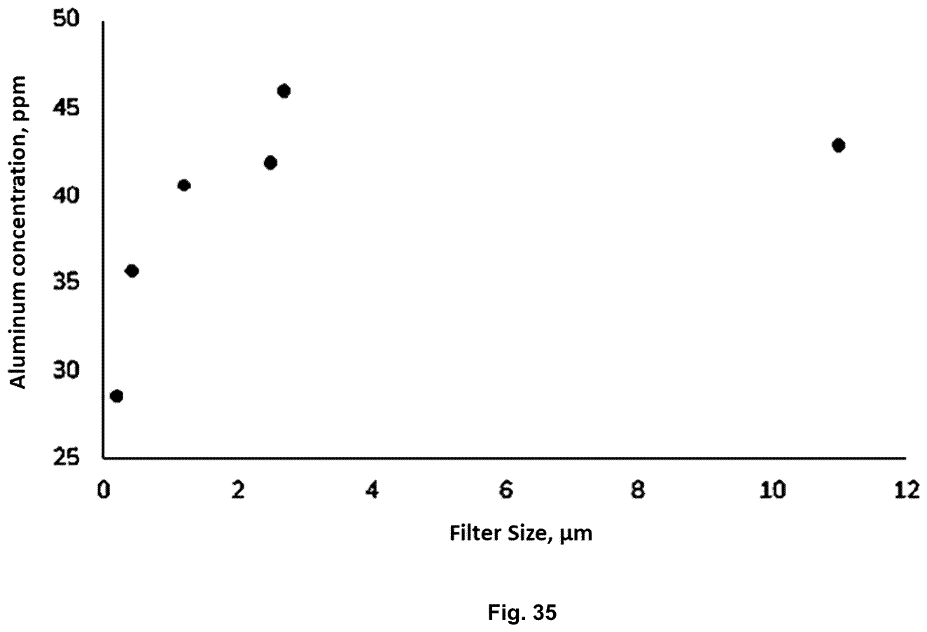

The present inventors have also discovered that aluminum contaminants can be removed from lithium bicarbonate by filtering an aqueous solution of lithium bicarbonate through a filter having a nominal pore size of about 1 μm or less. See FIG. 35. This is important because the raw lithium carbonate obtained from recycled batteries contains higher levels of aluminum than natural sources of lithium carbonate. The aluminum contaminants must be removed to yield battery-grade LiPF₆. It is known that these aluminum contaminants cannot be removed or reduced by conventional ion-exchange techniques.

It has been found by the present inventors that after converting lithium carbonate to lithium bicarbonate (by reacting it with carbon dioxide), aluminum contaminants present in the lithium bicarbonate can be significantly reduced by simple filtration. As shown in FIG. 35, the smaller the pore size, the more aluminum is removed from the lithium bicarbonate. It is preferred, although not required, that the lithium bicarbonate (in aqueous solution) be passed through a filter having a nominal pore size of about 1 μm or smaller. This allows for a lower grade of lithium carbonate (therefore a cheaper grade of lithium carbonate) to be used as the feedstock for the lithium hexafluorophosphate manufacturing process. It also makes the overall process more sustainable because even “dirtier” sources of lithium carbonate (such as from recycled batteries) can be used in the current process—and leave the process still economically viable. While not being limited to any particular underlying phenomenon, it is believed that aluminum in whatever form it exists in the feedstock lithium carbonate is converted to aluminum hydroxide at high pH and precipitates out as the pH decreases through the bicarbonation reaction. The resulting aluminum-containing precipitate can then be filtered from the lithium bicarbonate solution.

It has also been determined that centrifugation before filtration increases the efficacy of the filtration. By way of example (and not limitation), centrifugation was carried out at 110 rpm and the resulting centrifuged solution was then filtered as describe immediately above. Higher centrifugation speeds will produce a more significant effect. The centrifugation may optionally be conducted with a flocculant added to the mixture. Additionally, the combination of centrifugation followed by filtration also yielded decreases in the concentration of B, Ni, and P impurities. See Table 10 (all values are in ppm):

TABLE 10
Various impurities before and after
centrifuging/filtering LiHCO₃ (ppm).

| | Pre-Purification | Post-Centrifuge | Post-Filter |
|---|---|---|---|
| Element | LiHCO₃ | LiHCO₃ | LiHCO₃ |
| Al | 54.5 | 42.1 | 26.9 |
| B | 14.6 | 13.8 | 13.4 |
| Cu | 0.8 | 0.7 | 0.8 |
| Mn | 0.6 | 0.5 | 0.5 |
| Ni | 3.8 | 3.2 | 3.0 |
| P | 92.8 | 90.1 | 90.2 |

Phosphorus is another impurity commonly found in both natural and recycled sources of Li₂CO₃. Broadly speaking, phosphorus can be in an inorganic form (e.g., Li₃PO₄) or in an organic form (any compound containing a carbon-phosphorus bond). By way of example, due to the low aqueous solubility of Li₃PO₄, it can also be removed by filtration. As with aluminium contaminants, the removal of phosphorus contaminants via filtration is improved using the centrifugation/flocculant method described above.

### Ion Exchange Temperature

As described above, during Li₂CO₃ purification, an ion exchange step is performed to remove bivalent cations (e.g., Ca and Mg), as well as transition metals. In the process disclosed herein, the ion exchange is preferably carried out immediately after the conversion of Li₂CO₃ to LiHCO₃. At that point in the process, the solution is at approximately 0 to 5° C.

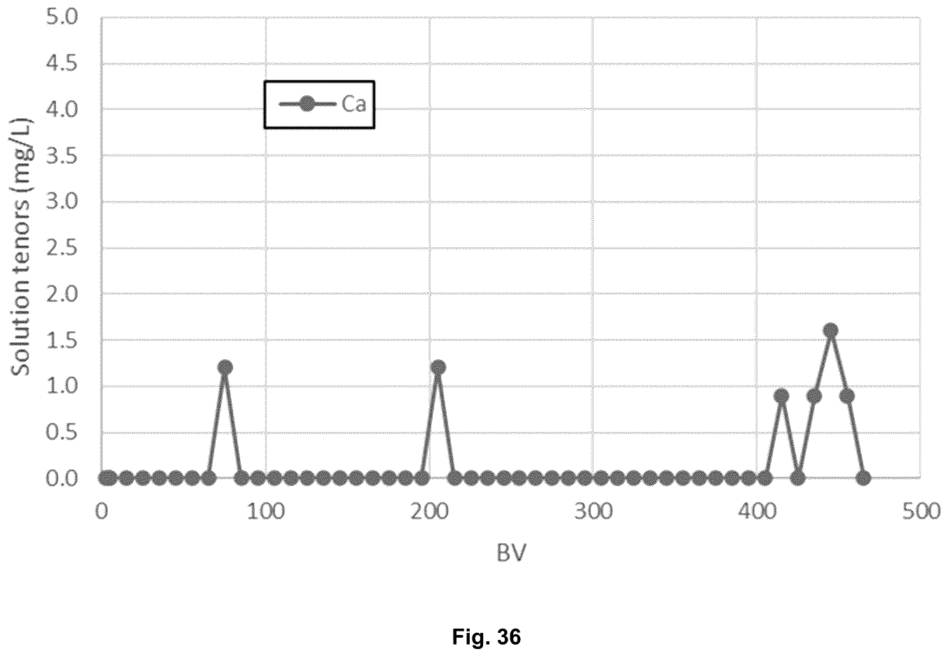

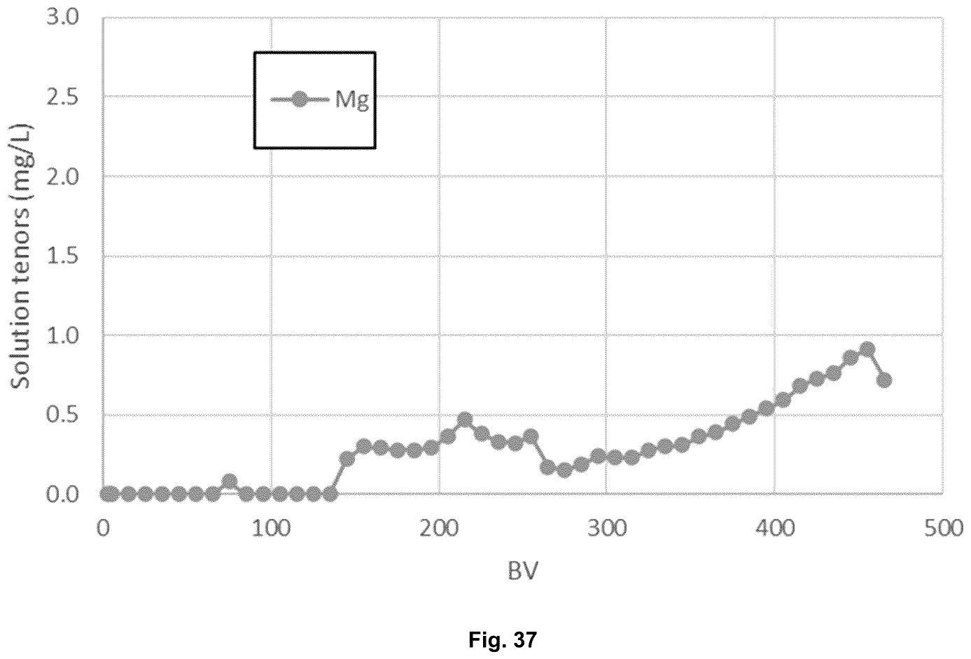

The efficiency of the ion exchange process, however, has been found to increase at higher temperatures. In short, it has been found that the total ion-exchange capacity of the resin is temperature dependent: the higher the temperature, the higher the capacity. Typical ranges for capacity are as follows: 0° C.<10%, 20° C.<25%, 60° C.=100%. Thus, more effective purification is achieved when the resin is operated at temperatures as high as possible consistent with the solution being processed. A balance must be struck because LiHCO₃ solutions become unstable above ˜40° C. and start to decompose back to Li₂CO₃. This causes precipitation of solids that would block the column. (See FIG. 8 and the accompanying discussion). Using technical grade lithium carbonate (Allkem Ltd.) with Ca²⁺ and Mg²⁺ impurities and Lanxess Lewatit Monoplus TP208 resin (Lanxess AG), experimental tests indicate that the resin has a capacity of about 400 bed volumes at 25° C. for calcium. Sec FIG. 36. This is far above the current process capacity at 5° C., which is about 100 bed volumes using battery-grade lithium carbonate. For magnesium, the resin has a capacity of about 140 bed volumes under the same conditions. See FIG. 37. In FIGS. 36 and 37, the spikes in the concentration measurements are due to two factors. The first factor is that the separations were not run continuously, but in “stop and go” fashion. The columns were stopped at night and re-started the following morning. During the period when the column was stopped, the column is no longer operating under plug flow conditions, but essentially as a batch process.

This allows the Ca to equilibrate with the resin when the mobile phase is at a standstill. The second reason is channelling through the resin. At the much smaller lab scale there is more wall effect than at full scale; some feed solution bypasses the bed. That is, in smaller columns, the column wall acts as a support to the filtration media. When the wall effect is large, the sample tends to flow near the column wall, thus decreasing its contact with the bed.

### Recovery of HCL

Making LiPF₆ per the present disclosure requires making PF₅ by the following reaction:

PCl₃+Cl₂+5HF→PF₅+5HCl

PF₅ and HCl have similar normal boiling points of approximately −85° C. PF₅ and HCl form a minimum boiling azeotrope which prevents complete separation by a single (simple) distillation step. Thus, in conventional methods of making PF₅, the HCl is not recovered because it's not economically feasible to separate it from the azeotropic mixture with PF₅. Disclosed herein, however, is a method for recovering the HCl as part of an integrated process along with the manufacture of PF₅ (as an intermediate to LiPF₆).

Rather than even attempting to separate the HCl/PF₅ azeotrope, HCl is recovered, either in anhydrous form or as an aqueous solution, from the LiPF₆ reactor off-gas (ROG) stream. Doing so has two distinct economic benefits. First, the HCl is recovered and can either be used for other internal needs, or sold as a value-added material. Second, removing the HCl from the ROG stream during the making of LiPF₆ reduces the acid load on the effluent treatment system. It thus provides a variable production cost benefit. Different options are available to achieve this recovery:
ROG scrubbing via a LiF-packed bed, which removes most or all the PF₅ (thereby yielding a scrubbed ROG stream), followed by distilling the scrubbed ROG stream to purify and recover the HCl from within the scrubbed ROG stream.
ROG scrubbing via a column containing HF, or other absorbent, which removes most or all the PF₅ (thereby yielding a scrubbed ROG stream), followed by distilling the scrubbed ROG stream to purify and recover the HCl from within the scrubbed ROG stream.
Simple distillation of the ROG stream to separate a portion of the PF₅ and an azeotropic amount of HCl. The distilled ROG stream thus has a higher concentration of HCl (because the PF5 has been removed, along with only some of the HCl in the azeotrope. The distilled ROG stream can be further purified via subsequent distillation steps to remove other impurities, before recovery of HCl.
Using extractive distillation to separate PF₅ from HCl, followed by simple distillation of the remaining stream to purify and recover at least a portion of the HCl.

What is claimed is:

1. A method to make LiF crystals, the method comprising: simultaneously adding aqueous LiHCO₃ and HF to a reactor containing water.

2. The method of claim 1, wherein the reactor contains only deionized water.

3. The method of claim 1, wherein the reactor contains an aqueous solution of LiF.

4. The method of claim 3, wherein the solution of LiF is saturated with LiF.

5. The method of claim 1, wherein the aqueous LiHCO₃ and HF are added to the reactor from above the surface of the water in the reactor.

6. The method of claim 1, wherein the aqueous LiHCO₃ and HF are added to the reactor from below the surface of the water in the reactor.

7. The method of claim 1, comprising adding LiF seed crystals to the reactor.

8. The method of claim 7, wherein the LiF seed crystals have a Dv50 of from about 3 μm to about 100 μm.

9. The method of claim 1, wherein the resulting LiF has a Dv50 particle size of from about 60 μm to about 90 μm.

10. The method of claim 1, wherein the aqueous LiHCO₃ is generated by reacting Li₂CO₃ with CO₂, wherein the Li₂CO₃ is technical grade.

11. The method of claim 1, further comprising filtering the aqueous LiHCO₃ through a filter having a nominal pore size of about 1 μm or less prior to adding the aqueous LiHCO₃ to the reactor.

12. The method of claim 11, further comprising centrifuging the aqueous LiHCO₃ prior to the filtering.

13. The method of claim 12, further comprising adding a flocculant to the aqueous LiHCO₃ prior to the centrifuging.

14. The method of claim 1, further comprising passing the aqueous LiHCO₃ through an ion exchange resin prior to adding the aqueous LiHCO₃ to the reactor, wherein the ion exchange resin is regenerated with LiOH.

15. The method of claim 1, further comprising adding a chelation of iron to the aqueous LiHCO₃ prior to adding the aqueous LiHCO₃ to the reactor.

16. A method to make PF₅ and HCl, the method comprising reacting PCl₃, Cl₂, and HF to yield PF₅ and HCl and recovering at least a portion of the PF₅ and at least a portion of the HCl from reactor effluent off-gas.

17. The method of claim 16, wherein HCl is recovered in anhydrous form.

18. The method of claim 16, wherein HCl is recovered as an aqueous solution.
